(19) United States
(12) Patent Application Publication
(10) Pub. No.: US 2026/0341990 A1
(43) Pub. Date: Oct. 29, 2026

(54) COMPACT AND RELIABLE CONNECTOR AND CONNECTOR ASSEMBLY

(71) Applicant: Amphenol Aorora Technology (Huizhou) Co., Ltd., Huizhou (CN)

(72) Inventors: Qi Han, Huizhou (CN); Xiaohong Zhu, Huizhou (CN)

(73) Assignee: Amphenol Aorora Technology (Huizhou) Co., Ltd., Huizhou (CN)

(21) Appl. No.: 19/706,746

(22) Filed: Jun. 12, 2026

Related U.S. Application Data
(63) Continuation of application No. PCT/CN2024/113594, filed on Aug. 21, 2024.

(30) Foreign Application Priority Data
Dec. 14, 2023 (CN) 202323424318.6

(51) Int. Cl. H01R 12/77; H01R 13/52; H01R 13/627; H01R 13/641

(52) U.S. Cl. CPC H01R 12/774; H01R 13/521; H01R 13/627; H01R 13/641; H01R 2201/26

(57) ABSTRACT

Compact and reliable connectors and connector assemblies. A receptacle connector includes a housing with a space and a seal cover, and conductive terminals. Each conductive terminal includes a mating end in the space, and a contact tail with a portion embedded in the seal cover. A plug connector includes a housing with a base portion and a first channel, a flat cable member with a connection end in the first channel, and a terminal position assurance (TPA) device coupled to the based portion and movable between a first pre-locked position where the TPA device is pre-installed to the base portion and a first locked position where the TPA device secures the flat cable member to the housing. A connector position assurance (CPA) device is pre-installed to the base portion and configured to secure the plug connector to the receptacle connector when mated.

### CROSS-REFERENCE TO RELATED APPLICATIONS

This application is a continuation of International Application No. PCT/CN2024/113594, filed on Aug. 21, 2024, entitled “CONNECTOR AND CONNECTOR ASSEMBLY,” which claims priority to and the benefit of Chinese Patent Application No. 202323424318.6, filed on Dec. 14, 2023. The contents of these applications are incorporated herein by reference in their entirety.

### TECHNICAL FIELD

The present application generally relates to interconnection systems, such as those including electrical connectors, used to interconnect electronic assemblies.

### BACKGROUND

Electrical connectors are used in many electronic systems, such as communication systems, data storage systems, and data transmission systems. It is generally easier and more cost-effective to manufacture an electronic system as separate electronic subassemblies, such as printed circuit boards (PCBs), which may be joined together by electrical connectors.

In some cases, PCBs to be joined may each have an electrical connector mounted thereon. The electrical connectors on the two PCBs may be mated directly to interconnect the two PCBs. In some other cases, the PCBs may be connected indirectly via a cable, or different locations on the same PCB may be connected via a cable. Electrical connectors may nonetheless be used to make such connections. For example, the cable may be terminated on one or both ends with a plug type of electrical connector. The PCB may be equipped with a receptacle type of electrical connector. The plug type electrical connector may be plugged into the receptacle type electrical connector to connect the cable to the PCB. A similar arrangement may be used at the other end of the cable, to connect the cable to another PCB, so that signals and/or power may pass between the PCBs via the cable.

Flat cable members such as a Flexible Printed Circuit (FPC) and a Flexible Flat Cable (FFC) may be used to transfer signals and/or power between different PCBs or components on the same PCB. FPC/FFC connectors are often used to connect the flat cable member to the PCB(s). FPC/FFC connectors are typically designed and manufactured according to specific specifications to mate with the flat cable member and the PCBs and to meet signal and/or power transmission requirements. Designing FPC/FFC connectors that meet the needs of a specific application brings a variety of challenges. FPC/FFC connectors must have a variety of characteristics that meet the mechanical and electrical requirements of the electronic system.

An example of a system in which assemblies are connected through cables is a modern automobile. For example, automotive vehicles include electronic control units (ECUs) for controlling various vehicle systems, such as the engine control unit, transmission control unit (TCUs), battery management system (BMS), cell sensing circuit (CSC), security systems, emissions control system, lighting control units, advanced driver assistance systems (ADAS), entertainment systems, navigation systems, and cameras. These electronic control units may be manufactured as separate assemblies. To simplify manufacture of an automobile, the assemblies may be connected via cables that are terminated with connectors that enable connections to mating board connectors terminating other cables or attached to printed circuit boards within the assemblies.

### SUMMARY

Aspects of the present disclosure relate to compact and reliable connectors and connector assemblies.

Some embodiments relate to an electrical connector. The electrical connector may comprise a housing comprising a space and a seal cover; and a plurality of conductive terminals, each of the plurality of conductive terminals comprising a mating end in the space of the housing, a contact tail, and an intermediate portion between the mating end and the contact tail, wherein the contact tail comprises a portion embedded in the seal cover of the housing.

Optionally, the seal cover comprises a first side facing towards the housing, the first side comprising a plurality of integral pillars configured for engagement with the housing.

Optionally, the housing comprises a plurality of holes configured to receive the plurality of integral pillars of the seal cover.

Optionally, the housing comprises a base portion and an accommodation portion opposite to each other in a lateral direction, and a plurality of channels in the base portion such that they are spaced from each other in a longitudinal direction perpendicular to the lateral direction; the plurality of conductive terminals are disposed in the plurality of channels; and the first side of the seal cover faces towards the base portion and covers the plurality of channels.

Optionally, the seal cover comprises a second side opposite the first side; and the electrical connector comprises a coating layer on at least the second side of the seal cover and enclosing portions of the contact tails of the plurality of conductive terminals.

Optionally, the coating layer is a high-temperature resistance coating layer and/or a coating layer of epoxy resin.

Optionally, the housing comprises a tongue portion extending from the base portion in the lateral direction; the plurality of channels extend into the tongue portion; and the contact tail of each of the plurality of conductive terminals protrudes at least partially from the tongue portion.

Optionally, the accommodation portion of the housing comprises a first wall and a second wall spaced from each other in a vertical direction perpendicular to both the longitudinal direction and the lateral direction, and a third wall and a fourth wall spaced from each other in the longitudinal direction; the space of the housing is bounded by the first wall, the second wall, the third wall, and the fourth wall and configured for receiving a mating electrical connector; and the first wall comprises a groove configured to receive a complementary feature of the mating electrical connector, and two lock holes.

Optionally, the mating end of each of the plurality of conductive terminals comprises a first beam and a second beam spaced from each other substantially in the vertical direction; the first beam comprises a first end and a second end opposite to the first end, and a first straight segment joining the first end and the second end, the first end connected to the intermediate portion, a first contact portion of the first beam at the second end; and the second beam comprises a third end and a fourth end opposite to the third end, a curved segment extending from the third end, and a second straight segment joining the curved segment and the fourth end, the third end connected to the intermediate portion, a second contact portion of the second beam at the fourth end.

Some embodiments relate to an electrical connector. The electrical connector may comprise a housing comprising a base portion and a first channel; a flat cable member comprising a connection end in the first channel of the housing, the connection end comprising a plurality of conductive contacts; and a first latch member coupled to the base portion of the housing and movable between a first pre-locked position and a first locked position relative to the housing, the first latch member configured to engage the connection end of the flat cable member in the first locked position and be separated from the connection end of the flat cable member in the first pre-locked position.

Optionally, the first latch member comprises a plate body and at least one first arm extending from the plate body in a vertical direction; and the at least one first arm is configured to engage the connection end of the flat cable member in the first locked position and be separated from the connection end of the flat cable member in the first pre-locked position.

Optionally, the base portion of the housing comprises at least one aperture in communication with the first channel; and the connection end of the flat cable member comprises at least one notch or slot configured to be aligned with the at least one aperture when the connection end of the flat cable member is inserted in the housing in place.

Optionally, the connection end of the flat cable member comprises a location port; and the housing comprises a third arm extending from the base portion and comprising a snap portion configured to engage the location port of the connection end of the flat cable member when the connection end of the flat cable member is inserted in the housing in place.

Optionally, the connection end of the flat cable member comprises a first outer profile and a second outer profile opposite to the first outer profile in a longitudinal direction; and the first outer profile is asymmetrical relative to the second outer profile such that the connection end of the flat cable member can be inserted in the first channel in only a predetermined orientation.

Optionally, the housing comprises an accommodation portion opposite to the base portion and extending in a lateral direction, the accommodation portion bounding a space in communication with the first channel; and an overhanging structure integral with the accommodation portion, the overhanging structure comprising a first resilient beam, a second resilient beam, and a third beam joining free ends of the first and second resilient beams, and the first and second resilient beams extending towards the base portion in the lateral direction.

Optionally, the base portion of the housing comprises a pair of grooves spaced from each other in a longitudinal direction perpendicular to the lateral direction; and the electrical connector comprises a second latch member movable along the pair of grooves between a second pre-locked position and a second locked position.

Optionally, the second latch member comprises a base body, a first resilient arm, and a second resilient arm, each of the first and second resilient arms comprising first and second ends opposite to each other in the lateral direction and connected to the base body, and a protrusion between the first and second ends; and each groove of the pair of grooves comprises first and second recesses spaced from each other in the lateral direction, the first recess configured to receive the protrusion of a respective one of the first and second resilient arms at the second pre-locked position, and the second recess configured to receive the protrusion of the respective one of the first and second resilient arms at the second locked position.

Some embodiments relate to a connector position assurance (CPA) device. The CPA device may comprise a base body; a first resilient arm comprising first and second ends connected to the base body, a first intermediate portion between the first and second ends of the first resilient arm, the first intermediate portion separated from the base body; and a second resilient arm comprising first and second ends connected to the base body, a second intermediate portion between the first and second ends of the second resilient arm, the second intermediate portion separated from the base body.

Optionally, the first resilient arm comprises a first protrusion between first and second ends of the first resilient arm; and the second resilient arm comprises a second protrusion between the first and second ends of the second resilient arm.

Optionally, the base body comprises a guide slot configured to receive a guide tongue of a connector housing.

Some embodiments relate to an electrical connector. The electrical connector may include an insulative housing; a plurality of conductive terminals arranged in the insulative housing and spaced from each other in a longitudinal direction, each conductive terminal including a mating end, a contact tail opposite to the mating end, and an intermediate portion joining the mating end and the contact tail, the mating end being within the insulative housing, the contact tail and the intermediate portion being at least partially within the insulative housing; and a seal cover. The seal cover may be attached on the conductive terminals and a part of the insulative housing such that only the contact tails of the conductive terminals are at least partially exposed from the seal cover.

Optionally, the seal cover includes a first side facing towards the insulative housing, on which first side a plurality of pillars are integrally formed for engagement with the insulative housing.

Optionally, at least one pillar of the plurality of pillars of the seal cover has at least two sections among which a section close to the first side of the seal cover has a diameter less than that of a section away from the first side of the seal cover.

Optionally, at least one pillar of the plurality of pillars of the seal cover is formed such that the at least one pillar has a diameter which gradually decreases as gradually approaching the first side of the seal cover.

Optionally, a plurality of receiving holes are formed in the insulative housing to receive the plurality of pillars of the seal cover.

Optionally, the plurality of receiving holes are shaped to be complementary to the plurality of pillars of the seal cover.

Optionally, the insulative housing includes a base portion and an accommodation portion opposite to each other in a lateral direction perpendicular to the longitudinal direction, a plurality of channels are formed in the base portion such that they are spaced from each other in the longitudinal direction, the plurality of conductive terminals are inserted in the plurality of channels, and the first side of the seal cover faces towards the base portion and covers the plurality of channels.

Optionally, the seal cover includes a second side from which the contact tails of the conductive terminals are exposed.

Optionally, a coating layer is sprayed onto at least the second side of the seal cover to enable the contact tails of the conductive terminals to be exposed from the coating layer.

Optionally, the coating layer is a high-temperature resistance coating layer and/or a coating layer of epoxy resin.

Optionally, the second side of the seal cover or the coating layer on the second side faces towards a printed circuit board when the electrical connector is welded to the printed circuit board via the contact tails of the conductive terminals.

Optionally, the seal cover is formed on the electrical connector via a process of secondary die molding, such that the seal cover at least partially covers the conductive terminals.

Optionally, the insulative housing also includes a tongue portion extending from the base portion in the lateral direction, the plurality of channels extend into the tongue portion, and the contact tail of each conductive terminal protrudes at least partially from the tongue portion when the plurality of conductive terminal are inserted in the plurality of channels.

Optionally, an accommodation space is defined by the accommodation portion for receiving another electrical connector mating with the electrical connector, and the tongue portion is disposed in the accommodation space.

Optionally, the plurality of channels are in communication with the accommodation space.

Optionally, the accommodation portion of the insulative housing includes a first wall and a second wall spaced from each other in a vertical direction perpendicular to both of the longitudinal direction and the lateral direction, and a third wall and a fourth wall spaced from each other in the longitudinal direction, and the accommodation space is defined by the first wall, the second wall, the third wall, and the fourth wall.

Optionally, in the accommodation space the mating ends of the conductive terminals protrude between the tongue portion and the second wall.

Optionally, a groove is formed in the first wall to be recessed into the first wall in the vertical direction to receive a complementary feature of another electrical connector mating with the electrical connector, such that the two electrical connector can be connected to each other in a unique orientation only.

Optionally, in the insulative housing, the first wall and the third wall are connected to each other at a first corner, the first wall and the fourth wall are connected to each other at a second corner, the second wall and the third wall are connected to each other at a third corner, and the second wall and the fourth wall are connected to each other at a fourth corner; the groove comprises a first groove recessed into the first wall in the vertical direction from the accommodation space at the first corner, and a second groove recessed into the first wall in the vertical direction from the accommodation space at the second corner.

Optionally, the groove also includes a third groove and a fourth groove which are located between the first groove and the second groove, and the first groove, the second groove, the third groove, and the fourth groove are disposed at the first wall only.

Optionally, two lock holes are formed in the first wall, and are located in the third groove and the fourth groove respectively.

Optionally, the mating end of the conductive terminal includes a first beam and a second beam, which beams are spaced from each other substantially in the vertical direction.

Optionally, in the conductive terminal, the first beam and the second beam are cantilever beams extending from the intermediate portion.

Optionally, the first beam comprises a first end and a second end opposite to the first end, and a first straight segment joining the first end and the second end, the first end is connected to the intermediate portion, a firs contact portion of the first beam is located at the second end; the second beam comprises a third end and a fourth end opposite to the third end, a curved segment extending from the third end, and a second straight segment joining the curved segment and the fourth end, the third end is connected to the intermediate portion, a second contact portion of the second beam is located at the fourth end, and the mating end is defined by the first contact portion and the second contact portion.

Optionally, when the electrical connector is connected to another mating electrical connector, the mating ends of the conductive terminals are in contact with corresponding conductive contacts of said another mating electrical connector.

Optionally, when the electrical connector is connected to said another mating electrical connector, the first contact portion of each conductive terminal contacts a respective conductive contact before the second contact portion of the conductive terminal contacts the respective conductive contact.

Some embodiments relate to an electrical connector. The electrical connector may include an insulative housing; a flat cable member, the flat cable member including a connection end having a plurality of conductive contacts, the connection end of the flat cable member being disposed in the insulative housing; and a first latch member, wherein the first latch member is installed to the insulative housing, and the first latch member is selectively switchable between a pre-locked position and a locked position relative to the insulative housing, the first latch member is configured to hold the connection end of the flat cable member in the insulative housing in the locked position of the first latch member.

Optionally, the insulative housing includes a base portion, a first channel is formed in the base portion, and the connection end of the flat cable member is inserted in the first channel.

Optionally, in the pre-locked position, the first latch member is not in engagement with the connection end of the flat cable member; in the locked position, the first latch member is in engagement with the connection end of the flat cable member to prevent the flat cable member from being removed out of the insulative housing.

Optionally, the first latch member includes a plate body and at least one first arm extending from the plate body in a vertical direction, and in the locked position only, the at least one first arm is in contact with the connection end of the flat cable member to prevent the flat cable member from being removed out of the insulative housing.

Optionally, at least one aperture is formed through and in the base portion of the insulative housing to be in communication with the first channel, at least one notch or slot is formed in the connection end of the flat cable member, and the at least one aperture is aligned with the at least one notch or slot when the connection end of the flat cable member is inserted in the insulative housing in place through the first channel.

Optionally, as the first latch member is switched between the pre-locked position and the locked position, the at least one first arm moves in the vertical direction, and only when the first latch member is in the locked position, the at least one first arm passes the at least one aperture and the at least one notch or slot which are aligned with each other in the vertical direction.

Optionally, an additional location port is formed in the connection end of the flat cable member, and the insulative housing also includes a third arm extending from the base portion into an accommodation space, the third arm is provided with a snap portion to engage the location port in the accommodation space when the connection end of the flat cable member is inserted in the insulative housing in place through the first channel.

Optionally, the connection end of the flat cable member has a first outer profile and a second outer profile opposite to the first outer profile in a longitudinal direction, and the first outer profile is asymmetrical relative to the second outer profile such that the connection end of the flat cable member can be inserted in the first channel in a given orientation only.

Optionally, the first outer profile and/or the second outer profile is formed with a step therein to contact a step complementarily formed in the first channel when the connection end of the flat cable member is inserted in the insulative housing in place through the first channel.

Optionally, the first latch member also includes two second arms located at a first end and a second end of the plate body opposite to each other in the longitudinal direction, the two second arms extend in the longitudinal direction; the base portion includes a first end face and a second end face opposite to each other in the longitudinal direction, a first groove recessed from the first end face into the base portion in the longitudinal direction, and a second groove recessed from the second end face into the base portion in the longitudinal direction, and the two second arms are received by the first groove and the second groove respectively.

Optionally, each of the first groove and the second groove is provided with a first snap portion and a second snap portion spaced from each other in the longitudinal direction, a snap-slot portion is formed in each second arm of the first latch member such that the first snap portion and the second snap portion can be located in the respective snap-slot portions.

Optionally, the first snap portion and the second snap portion are configured to define the pre-locked position and the locked position of the first latch member.

Optionally, a third groove is formed in the base portion to extend in the longitudinal direction to be in communication with the first groove and the second groove, and when the first latch member is in the locked position, the plate body of the first latch member is located in the third groove.

Optionally, the insulative housing also includes an accommodation portion opposite to the base portion and extending in a lateral direction perpendicular to the longitudinal direction, and the accommodation portion defines the accommodation space to be in communication with the first channel.

Optionally, when the connection end of the flat cable member is inserted in the insulative housing in place through the first channel, conductive contacts of the flat cable member are located in the accommodation space.

Optionally, the accommodation portion includes a first wall and a second wall spaced from each other in a vertical direction perpendicular to both of the longitudinal direction and the lateral direction, and a third wall and a fourth wall spaced from each other in the longitudinal direction, and the accommodation space is enclosed by the first wall, the second wall, the third wall, and the fourth wall.

Optionally, the accommodation portion includes a groove recessed into the first wall from an outer surface of the first wall of the accommodation portion in the vertical direction.

Optionally, the accommodation portion is integrally formed with an overhanging structure including a first resilient beam and a second resilient beam, and the first resilient beam and the second resilient beam extend from a bottom wall of the groove towards the base portion in the lateral direction respectively.

Optionally, the first resilient beam and the second resilient beam are spaced from each other in the longitudinal direction.

Optionally, each of the first resilient beam and the second resilient beam includes a first end and a second end opposite to each other in the lateral direction, the first end is fixed, and the second end is free.

Optionally, the overhanging structure also includes a third beam joining the second end of the first resilient beam and the second end of the second resilient beam.

Optionally, each of the first resilient beam and the second resilient beam is formed with a lock boss located between the first end and the second end, and the lock boss extends from an exposed face of the respective resilient beam.

Optionally, the electrical further comprises a second latch member movably installed in the base portion of the insulative housing to be selectively switchable between a pre-locked position and a locked position.

Optionally, the second latch member is closer to the accommodation portion in the locked position than in the pre-locked position of the second latch member.

Optionally, a pair of receiving slide grooves are formed in the base portion of the insulative housing and spaced from each other in the longitudinal direction to receive the second latch member therebetween.

Optionally, the second latch member includes a base body and a first resilient arm and a second resilient arm extending from the base body in the lateral direction, and the first resilient arm and the second resilient arm are opposite to each other in the longitudinal direction.

Optionally, each of the first resilient arm and the second resilient arm has a first end and a second end opposite to each other in the lateral direction such that each of the first resilient arm and the second resilient arm is connected to the base body of the second latch member via the first and second ends only, and a portion of the respective resilient arm except for the first and second ends is separated from the base body of the second latch member in the longitudinal direction.

Optionally, the first resilient arm and the second resilient arm of the second latch member are received by the pair of receiving slide grooves respectively such that they are slidable in the lateral direction.

Optionally, the first resilient arm is formed with a first protrusion between the first end and the second end thereof, the second resilient arm is formed with a second protrusion between the first end and the second end thereof; each of the pair of the receiving slide grooves is formed with a first recess and a second recess spaced from each other in the lateral direction, such that the first protrusion and the second protrusion can be selectively received in a pair of first recesses and a pair of second recesses respectively to define the pre-locked position and the locked position of the second latch member.

Optionally, a guide tongue portion extends from the accommodation portion of the insulative housing, and the guide tongue portion extends in the lateral direction, and extends at least partially between the pair of receiving slide grooves.

Optionally, the base body of the second latch member is formed with a guide slot in a side facing towards the insulative housing, and the guide slot is configured to receive the guide tongue portion when the second latch member is received by the pair of receiving slide grooves.

Optionally, the guide tongue portion is formed with a limitation protrusion on an end thereof away from the accommodation portion, a stop is formed on an end of the guide slot of the second latch member such that when the limitation protrusion is located in the guide slot, a travel of the second latch member moving away from the accommodation portion is restricted by the stop.

Optionally, in the pre-locked position of the second latch member, the first resilient arm and/or the second resilient arm and/or the third arm of the overhanging structure is movable towards the insulative housing.

Optionally, in the locked position of the second latch member, the base body of the second latch member is at least partially located in the vertical direction between the first resilient arm and/or the second resilient arm and/or the third arm and the insulative housing to prevent the first resilient arm and/or the second resilient arm and/or the third arm of the overhanging structure from moving towards the insulative housing.

Optionally, when the accommodation portion of the electrical connecter is inserted into an accommodation portion of another electrical connector, the lock boss of the first resilient beam and the lock boss of the second resilient beam can be received in a first lock hole and a second lock hole which are formed in the accommodation portion of said another electrical connector, respectively.

Optionally, in the locked position of the second latch member, the lock boss of the first resilient beam and the lock boss of the second resilient beam are prevented from escaping out of the first lock hole and the second lock hole.

Optionally, the flat cable member includes a flexible flat cable (FFC), a flexible printed circuit (FPC), or combination thereof.

Some embodiments relate to an electrical connector. The electrical connector may include an insulative housing having a base portion and an accommodation portion opposite to the base portion in a lateral direction, a first channel being formed in the base portion to receive a flat cable member; and a latch member, wherein the latch member is movably installed in the base portion of the insulative housing to be selectively switchable between a pre-locked position and a locked position, and the latch member is closer to the accommodation portion in the locked position than in the pre-locked position.

Optionally, the accommodation portion is integrally formed with an overhanging structure including a first resilient beam and a second resilient beam, and the resilient beam and the second resilient beam extend from a bottom wall of a groove towards the base portion in the lateral direction respectively.

Optionally, the first resilient beam and the second resilient beam are spaced from each other in a longitudinal direction.

Optionally, each of the first resilient beam and the second resilient beam includes a first end and a second end opposite to each other in the lateral direction, the first end is fixed, and the second end is free.

Optionally, the overhanging structure also includes a third beam joining the second end of the first resilient beam and the second end of the second resilient beam.

Optionally, each of the first resilient beam and the second resilient beam is formed with a lock boss located between the first end and the second end, and the lock boss extends from an exposed face of the respective resilient beam.

Optionally, a pair of receiving slide grooves are formed in the base portion of the insulative housing and spaced from each other in the longitudinal direction to receive the latch member therebetween.

Optionally, the latch member includes a base body and a first resilient arm and a second resilient arm which extend from the base body in the lateral direction, and the first resilient arm and the second resilient arm are opposite to each other in the longitudinal direction.

Optionally, each of the first resilient arm and the second resilient arm has a first end and a second end opposite to each other in the lateral direction such that each of the first resilient arm and the second resilient arm is connected to the base body of the second latch member via the first and second ends only, and a portion of the respective resilient arm except for the first and second ends is separated from the base body of the second latch member in the longitudinal direction.

Optionally, the first resilient arm and the second resilient arm of the latch member are received by the pair of receiving slide grooves respectively such that they are slidable in the lateral direction.

Optionally, the first resilient arm is formed with a first protrusion between the first end and the second end thereof, the second resilient arm is formed with a second protrusion between the first end and the second end thereof; each of the pair of the receiving slide grooves is formed with a first recess and a second recess spaced from each other in the lateral direction, such that the first protrusion and the second protrusion can be selectively received in a pair of first recesses and a pair of second recesses respectively to define the pre-locked position and the locked position of the latch member.

Optionally, a guide tongue portion extends from the accommodation portion of the insulative housing, and the guide tongue portion extends in the lateral direction, and extends at least partially between the pair of receiving slide grooves.

Optionally, the base body of the second latch member is formed with a guide slot in a side facing towards the insulative housing, and the guide slot is configured to receive the guide tongue portion when the latch member is received by the pair of receiving slide grooves.

Optionally, the guide tongue portion is formed with a limitation protrusion on an end thereof away from the accommodation portion, a stop is formed on an end of the guide slot of the second latch member such that when the limitation protrusion is located in the guide slot, a travel of the latch member moving away from the accommodation portion is restricted by the stop.

Optionally, in the pre-locked position of the latch member, the first resilient arm and/or the second resilient arm and/or the third arm of the overhanging structure is movable towards the insulative housing.

Optionally, in the locked position of the latch member, the base body of the latch member is at least partially located in the vertical direction between the first resilient arm and/or the second resilient arm and/or the third arm and the insulative housing to prevent the first resilient arm and/or the second resilient arm and/or the third arm of the overhanging structure from moving towards the insulative housing.

Optionally, when the accommodation portion of the electrical connecter is inserted into an accommodation portion of another electrical connector, the lock boss of the first resilient beam and the lock boss of the second resilient beam can be received in a first lock hole and a second lock hole which are formed in the accommodation portion of said another electrical connector, respectively.

Optionally, in the locked position of the latch member, the lock boss of the first resilient beam and the lock boss of the second resilient beam are prevented from escaping out of the first lock hole and the second lock hole.

Optionally, the electrical connector further comprises a flat cable member including a connection end having a plurality of conductive contacts, and the connection end of the flat cable member is inserted in the insulative housing through the first channel.

Optionally, the flat cable member includes a flexible flat cable (FFC), a flexible printed circuit (FPC), or combination thereof.

Some embodiments relate to an electrical connector assembly. The electrical assembly may include a first electrical connector having an insulative housing; and a second electrical connector having an insulative housing, wherein the first electrical connector is an electrical connector described herein, the insulative housing of the first electrical connector is defined with an accommodation portion to be inserted in an accommodation space defined by an accommodation portion of the insulative housing of the second electrical connector.

Optionally, the second electrical connector is an electrical connector described herein.

Optionally, after the accommodation portion of the first electrical connector is inserted in the accommodation space of the second electrical connector in place, conductive contacts of the first electrical connector are in conductive contact with conductive terminals of the second electrical connector.

Some embodiments relate to a method for assembling a first electrical connector and a second electrical connector together. The method may include providing an electrical connector already explained above as the first electrical connector; providing the second electrical connector; and/or inserting a connection end of a flat cable member into an insulative housing of the first electrical connector when a first latch member of the first electrical connector is in a pre-locked position thereof, and placing the first latch member in a locked position thereof after the connection end of the flat cable member has been inserted in place; and/or inserting an accommodation portion of the insulative housing of the first electrical connector into an accommodation space defined by an accommodation portion of an insulative housing of the second electrical connector when a second latch member of the first electrical connector is in a pre-locked position thereof, and then placing the second latch member in a locked position thereof to prevent the accommodation portion of the first electrical connector from being removed from the accommodation space.

Optionally, an electrical connector already explained above is provided as the second electrical connector.

Optionally, after the accommodation portion of the first electrical connector is inserted in the accommodation space of the second electrical connector in place, conductive contacts of the first electrical connector are in conductive contact with conductive terminals of the second electrical connector.

Some embodiments relate to a method for assembling a first electrical connector and a second electrical connector together is provided. The method may include providing an electrical connector already explained above as the first electrical connector; providing the second electrical connector; and/or inserting an accommodation portion of the insulative housing of the first electrical connector into an accommodation space defined by an accommodation portion of an insulative housing of the second electrical connector when a latch member of the first electrical connector is in a pre-locked position thereof, and then placing the latch member in a locked position thereof to prevent the accommodation portion of the first electrical connector from being removed from the accommodation space.

Optionally, an electrical connector already explained above is provided as the second electrical connector.

Optionally, after the accommodation portion of the first electrical connector is inserted in the accommodation space of the second electrical connector in place, conductive contacts of the first electrical connector are in electrical contact with conductive terminals of the second electrical connector.

These techniques can be used individually or in any suitable combination. The preceding summary is provided by way of illustration and is not intended to be limiting.

### BRIEF DESCRIPTION OF THE DRAWINGS

The above and other aspects of the present disclosure will be more thoroughly understood and appreciated below in conjunction with the appended drawings. It should be noted that the appended drawings are only schematic and are not drawn to scale. The same parts are indicated by the same reference numerals among the drawings. Further, for the purpose of concise illustration, not all components or parts of the electrical connector, the circuit board, and the electronic system according to the present disclosure are shown and indicated in the appended drawings. It should also be appreciated that the dimensions and the proportional relationships of the components or parts and the number of components in the appended drawings are not intended to form any limitations to the present disclosure. In the appended drawings:

FIG. 1 is a perspective view of an electronic system, including a first electrical connector (a plug connector), a second electrical connector (a receptacle connector), and a circuit board, according to some embodiments of the present disclosure;

FIG. 2 is another perspective view of the electronic system of FIG. 1, with the first electrical connector (the plug connector) and the circuit board removed;

FIG. 3 is an exploded perspective view of the first electrical connector (the plug connector) of the electronic system, showing a flat cable member to be received by the electrical connector;

FIG. 4 is yet another perspective view of the first electrical connector (the plug connector) of the electronic system, showing the flat cable member received by the electrical connector;

FIG. 5 is a perspective view of the flat cable member;

FIG. 6A is a perspective view of the first electrical connector (the plug connector), showing a first latch member of the connector in a pre-locked position and the flat cable member disposed in the insulative housing;

FIG. 6B is a perspective view of the first electrical connector (the plug connector), showing the first latch member of the connector in a locked position and the flat cable member locked in the insulative housing;

FIG. 7A is a cross-sectional view obtained along the line I-I in FIG. 6A;

FIG. 7B is a cross-sectional view obtained along the line I-I in FIG. 6B;

FIG. 8A is a perspective view of a base portion of an insulative housing of the first electrical connector;

FIG. 8B is yet another perspective view of the base portion of the insulative housing of the first electrical connector of FIG. 8A;

FIG. 8C is yet another perspective view of the base portion of the insulative housing of the first electrical connector of FIG. 8A;

FIG. 9A is a cross-sectional perspective view of the insulative housing of the first electrical connector (the plug connector) along the line III-III in FIG. 4, showing the flat cable member to be inserted into the insulative housing;

FIG. 9B is a cross-sectional perspective view of the insulative housing of the first electrical connector (the plug connector) along the line III-III in FIG. 4, showing the flat cable member inserted into the insulative housing;

FIG. 10A is a cross-sectional view of the insulative housing of the first electrical connector (the plug connector) along the line V-V in FIG. 8A, showing the flat cable member to be inserted into the insulative housing;

FIG. 10B is a cross-sectional view of the insulative housing of the first electrical connector (the plug connector) along the line V-V in FIG. 8A, showing the flat cable member inserted into the insulative housing;

FIG. 11A is a perspective view of a latch member (a second latch member) of the first electrical connector (the plug connector);

FIG. 11B is yet another perspective view of the latch member (the second latch member) of the first electrical connector (the plug connector);

FIG. 12A is a cross-sectional perspective view of the first electrical connector (the plug connector) along the line IV-IV in FIG. 4, showing the latch member (the second latch member) in a first position;

FIG. 12B is a cross-sectional perspective view of the first electrical connector (the plug connector) along the line IV-IV in FIG. 4, showing the latch member (the second latch member) in a second position;

FIG. 13A is a cross-sectional perspective view obtained along the line VII-VII in FIG. 4, showing the latch member (the second latch member) of the first electrical connector (the plug connector) in the first position corresponding to FIG. 12A;

FIG. 13B is a cross-sectional perspective view obtained along the line VII-VII in FIG. 4, wherein the latch member (the second latch member) of the first electrical connector (the plug connector) is shown in the second position corresponding to FIG. 12B;

FIG. 14A is a perspective view of the second electrical connector (the receptacle connector);

FIG. 14B is an exploded perspective view of the second electrical connector (the receptacle connector);

FIG. 15 is a perspective view of a single conductive terminal of the second electrical connector (the receptacle connector);

FIG. 16 is a cross-sectional view of the second electrical connector (the receptacle connector) along the line VII-VII in FIG. 14A, with a seal cover of the second electrical connector removed;

FIG. 17 is a cross-sectional view of the second electrical connector (the receptacle connector) along the line VII-VII in FIG. 14A, showing the seal cover of the second electrical connector;

FIG. 18A is a perspective view of the second electrical connector (the receptacle connector), with the seal cover of the second electrical connector removed;

FIG. 18B is a perspective view of the second electrical connector (the receptacle connector), showing the seal cover of the second electrical connector;

FIG. 18C is a partially cross-sectional perspective view of the second electrical connector (the receptacle connector) along the line A-A in FIG. 18B;

FIG. 18D is a partially cross-sectional perspective view of the second electrical connector (the receptacle connector) along the line B-B in FIG. 18B;

FIG. 18E is an enlarged view of a region of the second electrical connector (the receptacle connector) within a dotted box in FIG. 18D;

FIG. 18F is an enlarged view of a region of a second electrical connector (a receptacle connector) of anther embodiment corresponding to the region within the dotted box in FIG. 18D;

FIG. 19 is a perspective view of an electronic system configured according to some embodiments of the present disclosure;

FIG. 20 is a perspective view of a first connector configured according to some embodiments of the present disclosure;

FIG. 21 is a perspective view of a second connector configured according to some embodiments of the present disclosure;

FIG. 22 is a perspective view of a second housing configured according to some embodiments of the present disclosure;

FIGS. 23 and 24 are perspective views schematically illustrating a positioning snap configured according to some embodiments of the present disclosure;

FIG. 25 is a cross-sectional perspective view schematically illustrating a process of installing the positioning snap to the second housing according to some embodiments of the present disclosure;

FIG. 26 is a cross-sectional perspective view schematically illustrating the process of fitting the positioning snap configured according to some embodiments of the present disclosure to the second housing;

FIG. 27 is an exploded perspective view of a first connector configured according to some embodiments of the present disclosure, showing a circuit board to which the first connector may be mounted;

FIG. 28 is an exploded perspective view of a second connector configured according to some embodiments of the present disclosure;

FIG. 29 is a cross-sectional perspective view schematically illustrating an electronic system configured according to some embodiments of the present disclosure;

FIGS. 30 and 31 are cross-sectional views schematically illustrating the electronic system configured according to the embodiment of the present disclosure;

FIG. 32 is a perspective view schematically illustrating installation of an FPC assembly configured according to some embodiments of the present disclosure;

FIG. 33 is a cross-sectional perspective view schematically illustrating how a floating connection arm abuts an abutting feature configured according to some embodiments of the present disclosure;

FIG. 34A is a cross-sectional perspective view of the second electrical connector (the receptacle connector) along the line A1-A1 in FIG. 18B;

FIG. 34B is a cross-sectional perspective view of the second electrical connector (the receptacle connector) along the line A2-A2 in FIG. 18B, obtained in a view direction opposite to that of FIG. 34A;

FIG. 35A is a perspective view of a second electrical connector (a receptacle connector) according to another embodiment of the present disclosure, showing the second electrical connector (the receptacle connector) connected to a circuit board;

FIG. 35B is a cross-sectional view of the second electrical connector (a receptacle connector) along the line A3-A3 in FIG. 35A; and

FIG. 35C is a cross-sectional perspective view of the second electrical connector (a receptacle connector) along the line A4-A4 in FIG. 35A.

### DETAILED DESCRIPTION

Electrical connectors are used in many electronic systems. Electrical connectors can be joined together to form connector assemblies. Electrical connectors and connector assemblies have characteristics that meet the mechanical and electrical requirements of the electronic system. As an example, electrical connectors and connector assemblies need to have sufficiently high safety and reliability. For example, the electrical connector needs to have sufficiently high dielectric withstanding voltage performance. As another example, it is desired that the electrical connectors and connector assemblies have a small footprint in the electronic system. As another example, it is desired that the electrical connectors have good hot-plugging ability. As yet another example, it is desired that the connector assemblies allow for easy assembly and/or disassembly in a space-limited environment.

The inventors have recognized and appreciated electrical connector design techniques in which the electrical connectors have properties that meet the mechanical and electrical requirements of electronic systems. Such a technique enables the electrical connectors and connector assemblies that are compact, safe, reliable, and easier to assemble and disassemble, while meeting the mechanical and electrical requirements as specified by a specification such as USCAR. Such a technology can be particularly beneficial in a wire-to-board connection system.

The plug connector may include an insulative housing, a flat cable member, and a latch member. In an alternative embodiment, the flat cable member can be a member not belong to the plug connector, and can be embodiment as a member to be connected with the plug connector. The flat cable member includes a connection end having a plurality of conductive contacts. The connection end of the flat cable member can be disposed in the insulative housing. The latch member is mounted to the insulative housing and is configured to hold the connection end of the flat cable member in the insulative housing. With such a configuration, the connection end of the flat cable member may be disposed directly in the insulative housing to establish an electrical connection with a mating electrical component (e.g., a receptacle connector). Such a configuration can simplify the structure and reduce the manufacturing cost of the plug connector as compared to the conventional electrical connector that utilizes crimped cables to connect the flat cable. With the latch member, the connection end of the flat cable member can be reliably held in the insulative housing. Holding the flat cable member with a single latch member can simplify the construction and assembly process of the plug connector.

The latch member may be mounted to the insulative housing and may be selectively placed in a pre-locked position and a locked position. Such a configuration allows the plug connector to meet the requirements of a specification such as USCAR. As the latch member is pre-locked in position before the flat cable member is disposed in the insulative housing, loss of the latch member during disposing of the flat cable member can be avoided and the efficiency of assembly of the plug connector can be improved.

The conductive contacts of the flat cable member can be surrounded and protected by an accommodation portion of the insulative housing from being touched by a user's finger or by a tool, thereby prevent the user from getting electric shock or avoiding a short circuit. Such a configuration can improve the safety and reliability of the plug connector. The flat cable member may include a flexible flat cable (FFC), a flexible circuit board (FPC), or combination thereof.

The receptacle connector may include an insulative housing and a plurality of conductive terminals disposed in the insulative housing. The insulative housing may include a base portion and a tongue portion extending from the base portion in a lateral direction. The tongue portion may include a first surface and a second surface opposite to each other in a vertical direction perpendicular to the lateral direction. Each conductive terminal includes a mating end having a mating contact portion, a contact tail opposite to the mating end, and an intermediate portion joining the mating end and the contact tail. The plurality of conductive terminals may include a plurality of first conductive terminals and a plurality of second conductive terminals. The plurality of first conductive terminals are arranged in a first row in a longitudinal direction perpendicular to the lateral direction and the vertical direction, and the mating ends of the plurality of first conductive terminals extend into the tongue portion with the mating contact portions thereof protruding from the first surface. The plurality of second conductive terminals are arranged in a second row in the longitudinal direction, and the mating ends of the plurality of second conductive terminals extend into the tongue portion with the mating contact portions thereof protruding from the second surface. The mating ends of the plurality of first conductive terminals and the mating ends of the plurality of second conductive terminals may be offset from each other in the vertical direction. Such an arrangement enables the first row and the second row to be arranged at a smaller spacing in the vertical direction, while still ensuring sufficient spacing between the mating ends of the first conductive terminals and the mating ends of the second conductive terminals. Such an arrangement enables a reduction of the size (i.e., height) of the receptacle connector in the vertical direction Z. This facilitates miniaturization of the receptacle connector and enables a reduction of the footprint of the receptacle connector in the electronic system.

The base portion of the insulative housing of the receptacle connector may include a third surface and a fourth surface at a side opposite to the tongue portion. The third surface and the fourth surface are perpendicular to the lateral direction and face towards the same direction. The fourth surface is farther away from the tongue portion in the lateral direction than the third surface. The contact tails of the plurality of first conductive terminals extend out from the third surface of the base portion in the lateral direction, and the contact tails of the plurality of second conductive terminals extend out from the fourth surface of the base portion in the lateral direction. With such a configuration, the creepage distances between the contact tails of the plurality of first conductive terminals and the contact tails of the plurality of second conductive terminals can be increased, thereby allowing the plurality of first conductive terminals and the plurality of second conductive terminals to be arranged at closer spacing, and to increase the dielectric withstanding voltage performance of the receptacle connector. This enables to reduce the size of the receptacle connector in the lateral direction and/or in the longitudinal direction. This facilitates miniaturization of the receptacle connector and enables reduction of the footprint of the receptacle connector in an electronic system.

The mating end of the conductive terminal of the receptacle connector may have a double-beam-and-contact configuration. Such a configuration can improve the reliability of the electrical connection of the receptacle connector and effectively prevent transient breaks. Furthermore, such a configuration can improve the current-carrying capacity of the conductive terminals, thus enabling the receptacle connector to meet the needs of transmitting high currents. In addition, such a configuration can increase the contact density of the receptacle connector, thus facilitating miniaturization of the receptacle connector.

The plug connector and the receptacle connector may be mated with each other to form a connector assembly. A connector position assurance (CPA) device may reliably lock the plug connector and the receptacle connector together. Furthermore, the plug connector and the receptacle connector may have guide features that cooperate with each other. Such guide features can prevent the plug connector from being inserted into the receptacle connector in a skewed orientation, thereby providing protection to the mating conductive structures of the plug connector and the receptacle connector, and improving the hot-plugging ability of the connector assembly.

Some embodiments of the present disclosure are described in detail below in conjunction with the accompanying drawings. It should be appreciated that these embodiments are not meant to form any limitations to the present disclosure. Moreover, features in the embodiments of the present disclosure may be combined with each other.

### Electronic System

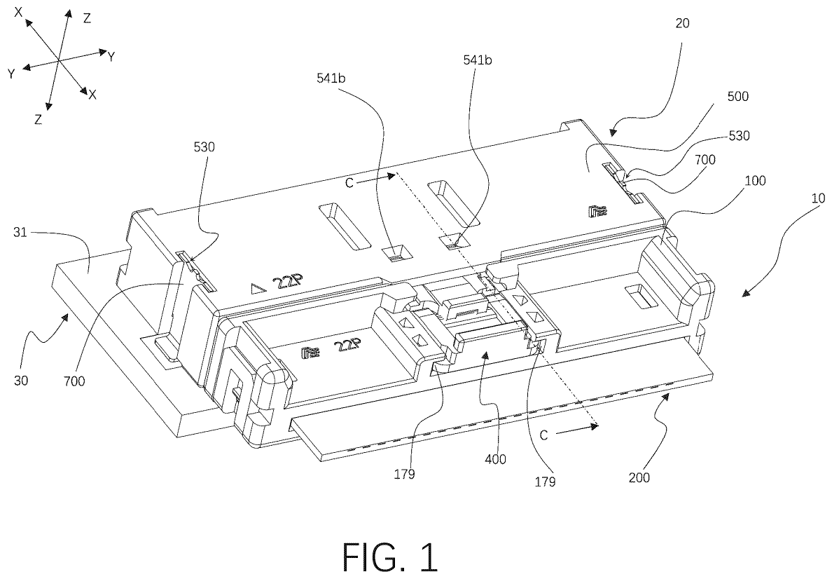

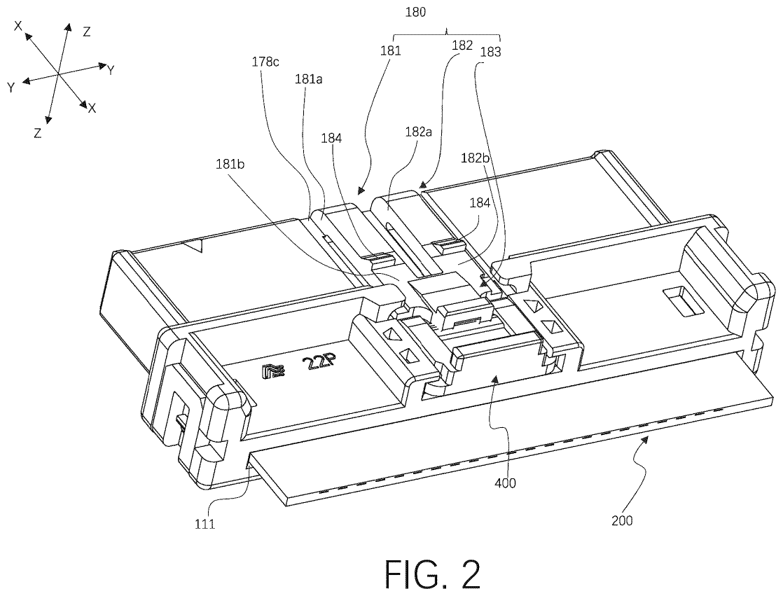

FIGS. 1 and 2 schematically illustrate an electronic system 1, including an electrical connector 10, an electrical connector 20, and a circuit board 30, according to some embodiments of the present disclosure.

For the sake of clarity and conciseness of the description, a lateral direction X-X, a longitudinal direction Y-Y, and a vertical direction Z-Z are defined in FIG. 1. The lateral direction X-X, the longitudinal direction Y-Y, and the vertical direction Z-Z are perpendicular to each other. The lateral direction X-X usually refers to a width direction of the electrical connector 10 and the electrical connector 20. The longitudinal direction Y-Y usually refers to a length direction of the electrical connector 10 and the electrical connector 20. The vertical direction Z-Z usually refers to a height or thickness direction of the electrical connector 10 and the electrical connector 20.

As shown by FIGS. 1 and 2, the electronic system 1 includes the electrical connector 10, the electrical connector 20, and the circuit board 30.

The circuit board 30 may also be referred to as “a printed circuit board” or “a PCB”. The circuit board 30 may be a motherboard, such as a motherboard for a battery management system (BMS).

The electrical connector 20 may be an on-board connector that is mounted on and connected to the circuit board 30. In particular, the electrical connector 20 may be mechanically secured to the circuit board 30 and electrically connected to conductive structures (e.g., conductive pads or conductive through-holes) of the circuit board 30. The electrical connector 20 may provide an electrical interface for electrically connecting the electrical connector 10 to the circuit board 30.

The electrical connector 10 may be configured to electrically connect an electrical component to the electrical connector 20 and the circuit board 30. The electrical component may be, for example, a Cell Sensing Circuit (CSC). The CSC is configured for monitoring the state (e.g., the voltage and the temperature) of a battery cell.

The electrical connector 10 and the electrical connector 20 may establish an electrical connection between the circuit board 30 and the electrical component for signal and/or power transmission. For example, state data of the battery cell acquired by the CSC may be transferred to a data obtaining module of the BMS via the electrical connector 10 and the electrical connector 20. The electrical connector 10 and the electrical connector 20 may constitute a connector assembly for signal and/or power transmission. It should be appreciated that the usage of the electronic system 1 and the connector assembly according to the present disclosure are not limited thereto. In some other embodiments, the electrical connector 10 and the electrical connector 20 may be used in an On-board Charger (OBC), a micro control unit (MCU), and the like.

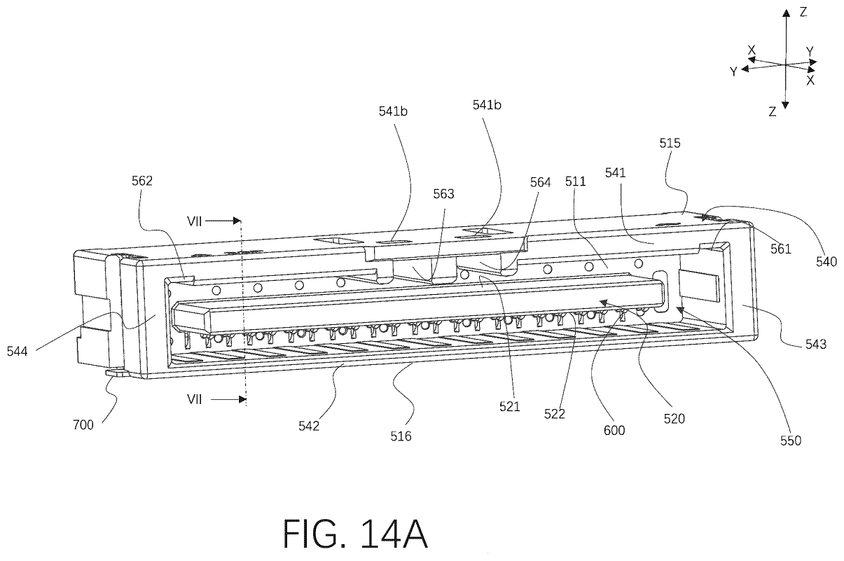

As shown by FIGS. 1 and 2, the electrical connector 20 is disposed on a surface 31 of the circuit board 30 and is electrically connected to the conductive structures 32 (which are illustrated as conductive pads in FIG. 14B) of the circuit board 30. As will be described in detail below, a portion of the electrical connector 10 is inserted into a housing of the electrical connector 20 so that the conductive structures of the electrical connector 10 mate with the mating conductive structures of the electrical connector 20. The electrical connector 10 may also be referred to as “a first electrical connector” or “a plug connector”, and the electrical connector 20 may also be referred to as “a second electrical connector” or “a receptacle connector”.

### Plug Connector

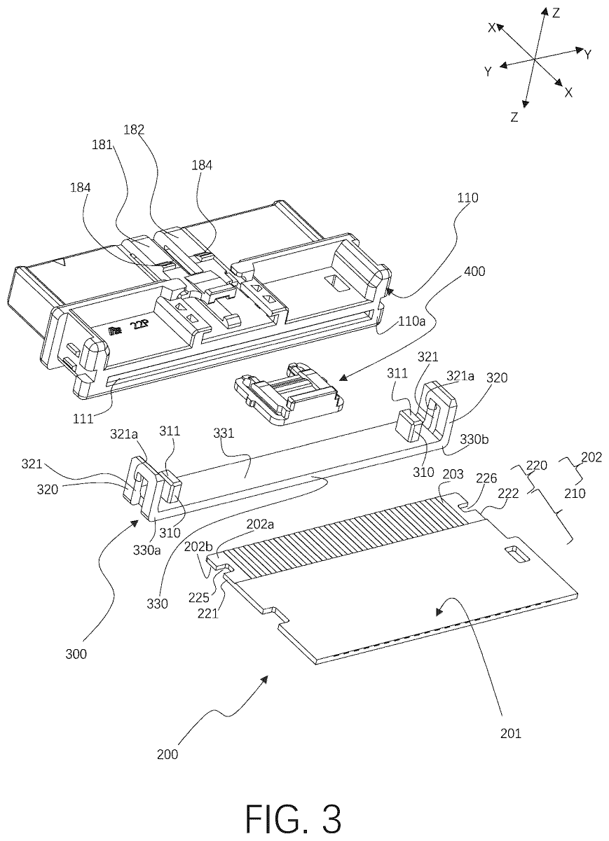

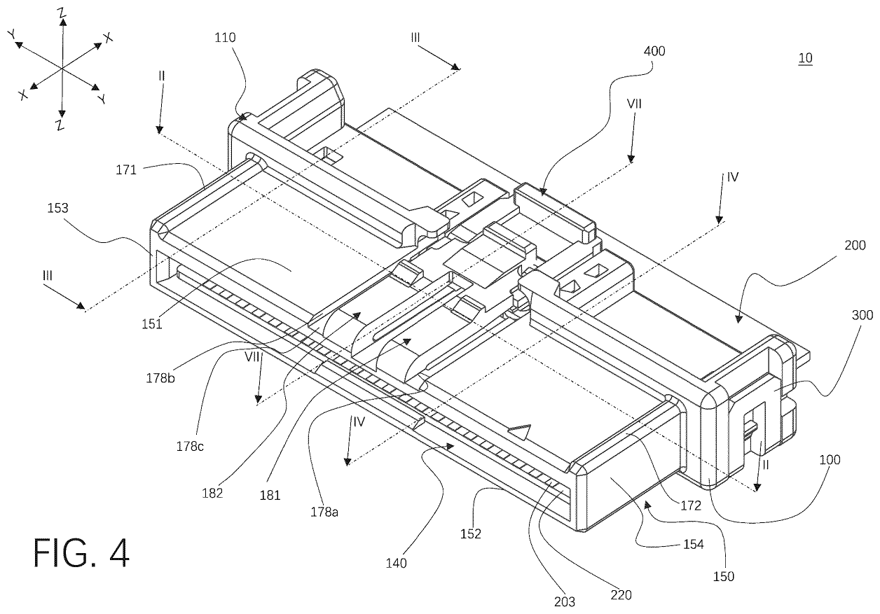

FIGS. 3 and 4 illustrate in detail the configuration of the electrical connector 10. As shown by FIGS. 3 and 4, the electrical connector 10 may include an insulative housing 100, a plurality of flat cable members 200, a latch member 300, and a latch member 400. The latch member 300 may also be referred to as “a first latch member” or “an FPC/FFC position assurance (FPA) device”. The latch member 400 may also be referred to as “a second latch member”. The latch member 400 may be made of an insulative material. Examples of insulative materials suitable for forming the latch member 400 include, but are not limited to, plastic, nylon, liquid crystal polymer (LCP), polyphenylene sulfide (PPS), high temperature nylon or polyphenylene oxide (PPO) or polypropylene (PP). In an alternative embodiment, the electrical connector 10 can include only one of the latch members 300 and 400.

The electrical connector 10 is configured to releasably receive the flat cable member 200. The flat cable member 200 may be a flexible electrical connection member with a flat shaped connection end. The flat cable member 200 may also be referred to as “a flat cable”. For example, the flat cable member 200 may be electrically connected to an electrical component, such as a CSS as described above, or the flat cable member 200 may itself be a part of an electrical component such as a CSS as described above. The flat cable member 200 may, for example, be a Flexible Printed Circuit (FPC) or a Flexible Flat Cable (FFC). The flat cable member 200 received by the electrical connector 10 may include an FFC, an FPC, or the combination thereof.

In an alternative embodiment (not shown here), the flat cable member 200 may comprise at least two flat cable members. For example, the flat cable member 200 may comprise two flat cable members spaced from each other in the vertical direction Z-Z. The flat cable member 200 is substantially planar, and has two opposing sides. For example, one side of the flat cable member 200 is schematically illustrated in FIG. 3. As shown, the flat cable member 200 includes a main body 201 and a connection end 202.

The connection end 202 may have a flat shape. The connection end 202 may include a first surface 202a and a second surface 202b opposite to each other in the vertical direction Z-Z. A plurality of conductive contacts 203 may be exposed at the first surface 202a of the connection end 202. The conductive contacts 203 may also be referred to as “conductive contact strips” or “gold fingers”. The conductive contacts 203 may be formed from a conductive material. The conductive material suitable for forming the conductive contact 203 may be a metallic material, such as a copper alloy. The main body 201 may extend from the connection end 202 to the other end (not shown) of the flat cable member 200, and may provide an electrical connection between the connection end 202 and the other end, thereby enabling signal and/or power transmission. The main body 201 may, for example, be flexible so as to be suitable for bending. The connection end 202 may be stiffened so as to be suitable for being inserted into the insulative housing 100 as well as for establishing an electrical connection with a mating electrical component (e.g., the electrical connector 20).

As shown, the connection end 202 of the flat cable member 200 can be releasably received by or disposed in the insulative housing 100. The latch member 300 can be installed in the insulative housing 100, and can be configured to hold and lock the connection end 202 of the flat cable member in the insulative housing 100.

With such a configuration, the connection end 202 of the flat cable member 200 may be releasably received by or disposed in the insulative housing 100 to establish electrical connections with a mating electrical component. Such a configuration can simplify the structure of the electrical connector 10 and reduce the production cost thereof as compared to conventional electrical connectors that utilize crimped cables to connect the flat cable. With the latch member 300, the connection end 202 of the flat cable member 200 can be reliably held in the insulative housing 100.

The insulative housing 100 and the latch member 300 may be formed from an insulative material. Examples of insulative materials include, but are not limited to, plastic, nylon, liquid crystal polymer (LCP), polyphenylene sulfide (PPS), high temperature nylon or polyphenylene oxide (PPO) or polypropylene (PP).

As shown by FIG. 3, the insulative housing 100 includes a base portion 110, and a first channel 111 respectively extending through the base portion 110 from a first face 110a of the base portion 110 in the lateral direction X-X. As shown, the connection end 202 of the flat cable member 200 may include a first segment 210 and a second segment 220. The first segment 210 of the connection end 202 extends from the main body 201 in the lateral direction X-X, and the second segment 220 extends from the first segment 210 away from the main body 201 in the lateral direction X-X. For example, the first segment 210 extends between the second segment 220 and the main body 201 and joins the second segment 220 and the main body 201. The flat cable member 200 may terminate at the second segment 220. The plurality of conductive contacts 203 are disposed on the second segment 220. The structure of the connection end 202 of the second flat cable member 200B is substantially the same as that of the connection end 202 of the first flat cable member 200A. For the sake of brevity, the details of these identical portions may not be repeated.

As shown by FIGS. 2 and 3, the connection end 202 of the flat cable member 200 may be inserted into the insulative housing 100 from the first face 110a of the base portion 110 through the first channel 111. When the flat cable member 200 is received by or disposed in the insulative housing 100 in place, the first segment 210 of the connection end 202 of the flat cable member 200 is disposed in the first channel 111. With such a configuration, the base portion 110 can restrict the movement of the first segment 210 of the connection end 202 of the flat cable member 200 relative to the insulative housing 100 in the longitudinal direction Y-Y and the vertical direction Z-Z, thereby holding the connection end 202 of the flat cable member 200 in the longitudinal direction Y-Y and the vertical direction Z-Z.

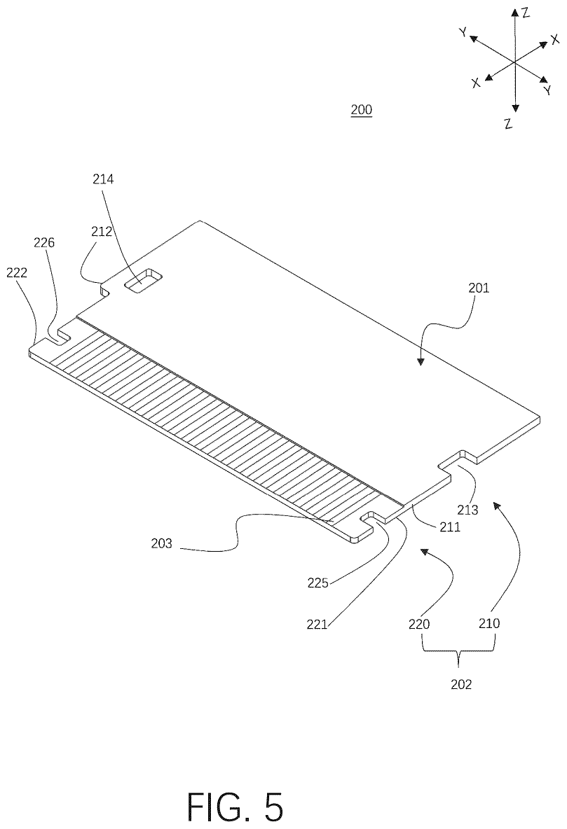

As shown by FIG. 5, the first segment 210 of the connection end 202 of the flat cable member 200 has a side edge. For example, the first segment 210 of the connection end 202 of the flat cable member 200 includes a first side edge 211 and a second side edge 212 opposite to each other in the longitudinal direction Y-Y.

In some embodiments of the present disclosure, the first segment 210 of the first flat cable member 200 may include a notch (or slot) recessed into the first segment 210 from the side edge in the longitudinal direction Y-Y and/or a notch (or slot) formed through the first segment 210 in the vertical direction Z-Z adjacent to the side edge. For example, as shown by FIG. 5, the first segment 210 of the flat cable member 200 may include a first notch (or slot) 213 recessed into the first segment 210 from the first side edge 211 in the longitudinal direction Y-Y and a second notch (or slot) 214 formed through the first segment 210 in the vertical direction Z-Z adjacent to the side edge 212. It should be understood by a person skilled in the art that the shape and position of the groove and/or the notch can be re-configured depending on the concrete requirements of the embodiments of the present disclosure, as soon as the groove and/or the notch can meet the requirements of the embodiment of the present disclosure.

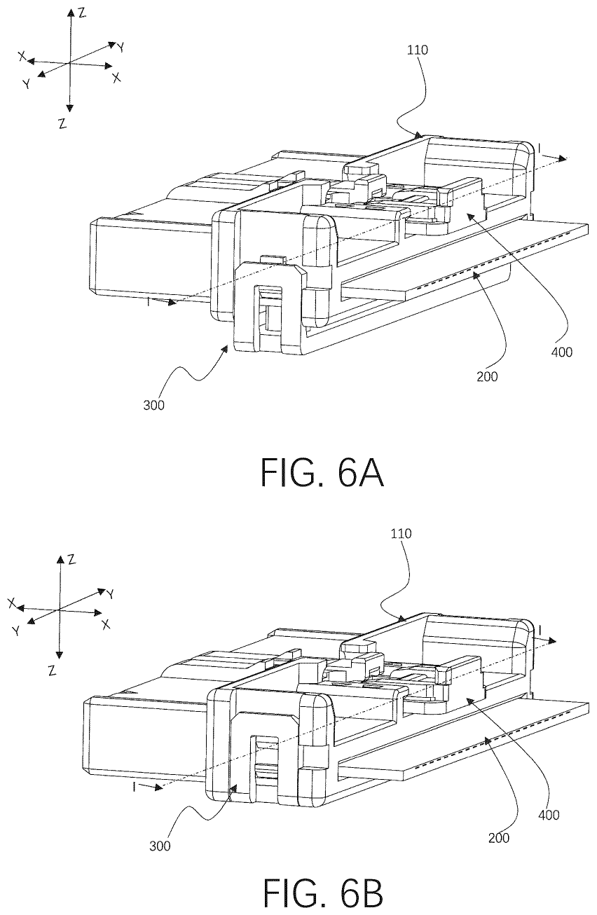

As shown by FIGS. 6A and 6B, the latch member 300 is installed to the base portion 110 and is configured to be capable of being selectively placed in a pre-locked position (FIG. 6A) and a locked position (FIG. 6B). For example, the latch member 300 is capable of being selectively switchable between a pre-locked position/state (FIG. 6A) and a locked position/state (FIG. 6B) and still remain held and installed to the base portion 110. During switching between the pre-locked position and the locked position, the latch member 300 is selectively movable in the vertical direction Z-Z.

In the pre-locked position as shown by FIG. 6A, the latch member 300 is not in engagement with the flat cable member 200 to allow the first segment 210 or the second segment 220 of the flat cable member 200 to move and enter the first channel 111 in the lateral direction X-X. In the pre-locked position, the latch member 300 is separated from the connection end 202 of the flat cable member 200. For example, in the pre-locked position of the latch member 300, the connection end 202 of the flat cable member 200 is allowed to be inserted from the face 110a of the base portion 110 into the insulative housing 100 through the first channel 111.

In the locked position as shown by FIG. 6B, the latch member 300 is in engagement with or interacts with the flat cable member 200A to hold the first segment 210 in the first channel 111. In the locked position of the latch member 300, the first segment 210 is prevented from moving in the first channels 111 in the lateral direction X-X, so as to prevent it from being pulled out of the insulative housing 100 or the base portion 110, thereby holding the first segment 210 in the first channel 111. In this way, the latch member 300 can hold the flat cable member 200 relative to the insulative housing 100 or the base portion 110.

When placed in the pre-locked position, the latch member 300 can allow the connection end 202 of the flat cable member 200 to be inserted into the insulative housing 100. When placed in the locked position, the latch member 300 holds the connection end 202 of the flat cable member 200 in the insulative housing 100. Such a configuration can allow the latch member 300 to be installed to the insulative housing 100 (i.e., allow to pre-lock the latch member 300 in position), prior to insertion of the flat cable member 200 into the insulative housing 100, and allow to lock the flat cable member 200 in position using the latch member 300 pre-installed to the insulative housing 100, after the insertion of the flat cable member 200 into the insulative housing 100. Such a configuration enables the electrical connector 10 to meet the requirements of the specification such as USCAR. As the latch member 300 is pre-locked in position prior to the insertion of the flat cable member 200 into the insulative housing 100, loss of the latch member 300 can be avoided during installation of the flat cable member 200, and the efficiency of assembly of the electrical connector 10 can be improved.

As shown by FIG. 3, the latch member 300 may include two first arms 310. Each first arm 310 includes a first body 311 extending in the vertical direction Z-Z. The latch member 300 may include a plate body 330, which may also be referred to as “a press plate”. Each of the two first arms 310 extends from the plate body 330 in the vertical direction Z-Z. The latch member 300 may further include two second arms 320. The two second arms 320 may be configured to attach the latch member 300 to the base portion 110 of the insulative housing 100. Each of the second arms 320 extends from the plate body 330 in the vertical direction Z-Z and includes a snap-slot portion 321. The plate body 330 of the latch member 300 includes a first end 330a and a second end 330b opposite to each other in the longitudinal direction Y-Y. Two second arms 320 extend from a first surface 331 of the plate body 330 in the vertical direction Z-Z at the first end 330a and the second end 330b, respectively. The two first arms 310 may extend from the first surface 331 of the plate body 330 in the vertical direction Z-Z between the two second arms 320. The second arms 320 may be flexible arms. The snap-slot portions 321 may be elongated in the vertical direction Z-Z. The snap-slot portions 321 of the two second arms 320 are opposite to each other in the longitudinal direction Y-Y.

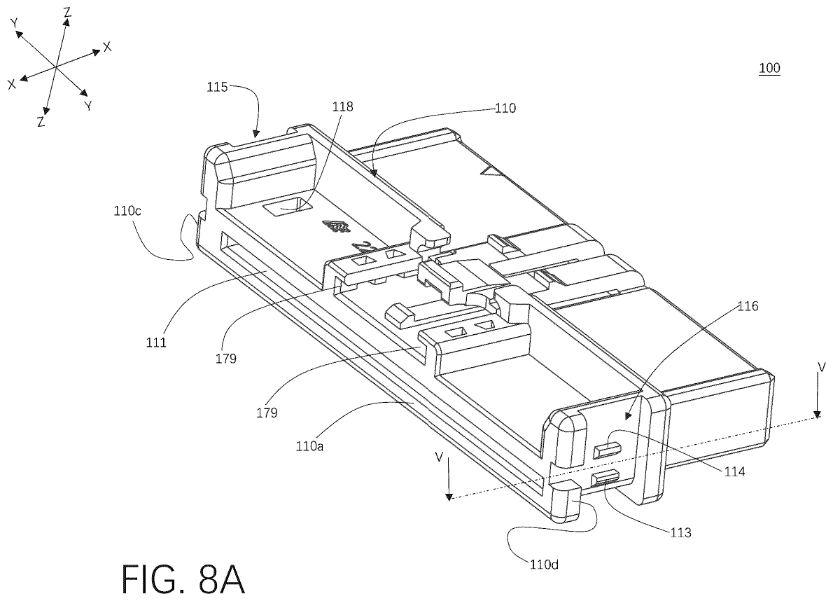

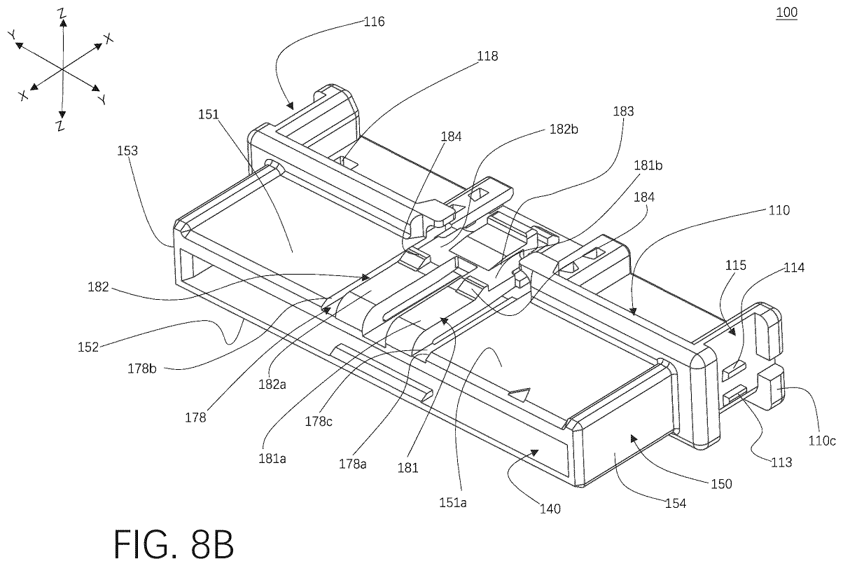

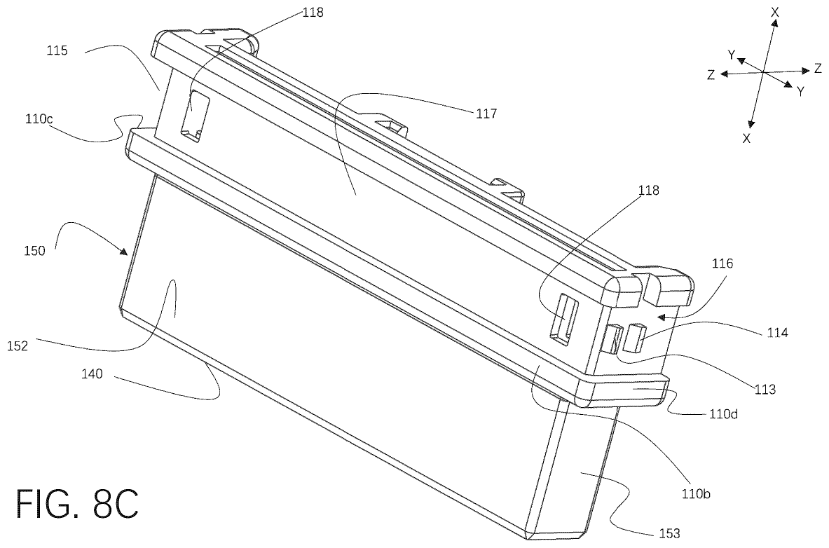

As shown by FIGS. 8A, 8B, and 8C, the base portion 110 includes a first end face 110c and a second end face 110d opposite to each other in the longitudinal direction Y-Y, a first groove 115 recessed into the base portion 110 from the first end face 110c in the longitudinal direction Y-Y, and a second groove 116 recessed into the base portion 110 from the second end face 110d in the longitudinal direction Y-Y. Furthermore, a third groove 117 is formed in a second or bottom face 110b of the base portion 110. For example, the third groove 117 is recessed into the base portion 110 from the second or bottom face 110b in the vertical direction Z-Z. For example, the third groove 117 is elongated and matches the shape of the plate body 330. The third groove 117 is in communication with both of the first groove 115 and the second groove 116.

When the latch member 300 is installed to the base portion 110, the two second arms 320 of the latch member 300 are received in the second groove 116 and the third groove 117 respectively, with the plate body 330 of the latch member 300 being located in the third groove 117 and the first surface 331 of the plate body 330 facing towards the insulative housing 100 or the base portion 110 thereof. In this way, the two second arms 320 and the plate body 330 of the latch member 300 can be protected by the base portion 110 from loosening from the base portion 110 due to inadvertent touching. With such a configuration, the reliability of the installation of the latch member 300 to the base portion 110 can be improved, and the installation, adjustment, and removal of the latch member 300 can be facilitated.

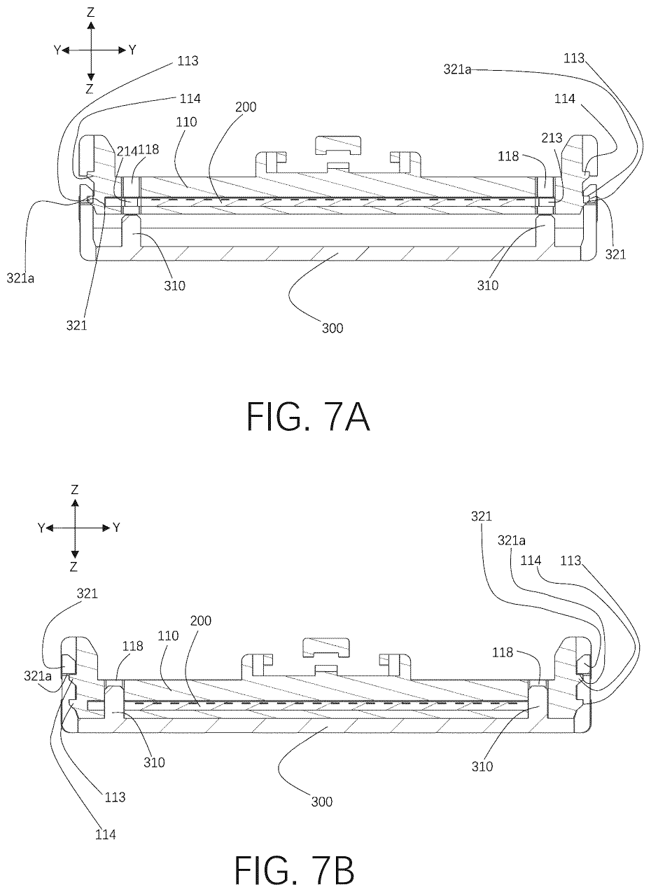

As shown by FIGS. 8A to 8C, the base portion 110 can comprise two first snap portions 113 and two second snap portions 114. For example, a pair of first and second snap portions 113 and 114 are disposed in each of the first groove 115 and the second groove 116. Each snap portion is formed such that it protrudes outwards from a bottom face of the respective first groove 115 or second groove 116. The first snap portion 113 and the second snap portion 114 are shaped such that they can be received in snap-slots of the respective snap-slot portions 32 of the respective second arms 320 of the latch member 300. In this way, when the latch member 300 is installed to the base portion 110 and the two second arms 320 of the latch member 300 are received by the first groove 115 and the second groove 116 respectively, a contact face 321a (see FIGS. 3, 7A and 7B) of the snap-slot portion 321 can selectively contact the respective first snap portion 113 (FIG. 7A) or the respective second snap portion 114 (FIG. 7B). For example, in FIG. 7A, the latch member 300 is placed in the pre-locked position, the contact face 321a of the snap-slot portion 321 of each of the two second arms 320 of the latch member 300 contacts a corresponding one of the first snap portions 113. In the meanwhile, as the latch member 300 is forced in the vertical direction Z-Z to move, the latch member 300 can be switched to the locked position. As shown by FIG. 7B, the contact face 321a of the snap-slot portion 321 of each of the two second arms 320 of the latch member 300 contacts a corresponding one of the second snap portions 114. With such a snap fit, the latch member 300 can be reliably held in the pre-locked position and the locked position, while the switching of the latch member 300 between the pre-locked position and the locked position can be facilitated.

For example, when the latch member 300 is placed in the pre-locked position, the latch member 300 may be pushed by pressing the plate body 330 in the vertical direction Z-Z to cause the contact faces 321a of the snap-slot portions 321 of the two second arms 320 to move from the respective first snap portions 113 to the respective second snap portions 114, so as to move the latch member 300 to the locked position. When the latch member 300 is placed in the locked position, the two second arms 320 may be released from the corresponding second snap portions 114 by separating the two arms slightly, to enable the contact faces 321a of the snap-slot portions 321 of the two second arms 320 to fit onto the respective first snap portions 113, so as to place the latch member 300 in the pre-locked position. In the illustrated embodiment, each snap portion 113 or 114 is provided with a slope, while a free end face of the respective snap-slot portion 321 is also correspondingly sloped such that slidable friction between the slopes can facilitate switching the latch member 300 from the pre-locked position to the locked position.

In FIG. 3, a center or central line in the longitudinal direction Y-Y between the two first arms 310 of the latch member 300 may not overlap with a center or central line in the longitudinal direction Y-Y between the two second arms 320. Such a configuration can provide a fool-proof (i.e., Poka-Yoke) function to prevent the latch member 300 from being installed to the base portion 110 in an improper orientation. As shown by FIGS. 8A to 8C, two apertures 118 are formed through and in the base portion 110. For example, the two apertures 118 can be formed through both of a bottom face of the third groove 117 and a side of the base portion 110 opposite (in the vertical direction Z-Z) to a side where the third groove 117 locates. The two apertures 118 are configured such that the two first arms 310 can pass them respectively, to enable the latch member 300 to be switched between the pre-locking and locked positions when it is installed in the base portion 110.

FIGS. 6A and 7A illustrate that the latch member 300 is in the pre-locked position. In this case, the flat cable member 200 can be at least partially inserted into the first channel 111 of the base portion 110 in the lateral direction X-X. Since the latch member 300 is in the pre-locked position, the latch member 300 is not in engagement with the flat cable member 200, this means that the flat cable member 200 can be removed from the base portion 110 if required. For example, the connection end 202 of the flat cable member 200 is thus enabled to be inserted into the insulative housing 100 and removed therefrom in the lateral direction X-X. As the latch member 300 has been in the pre-locked position and the flat cable member 200 has been inserted in the base portion 110 in place, the first notch 213 and the second notch 214 of the flat cable member 200 can be aligned with the two apertures 118 of the base portion 110 in the lateral direction X-X, respectively.

As the latch member 300 is switched into the locked position, as shown by FIGS. 6B and 7B, the two first arms 310 of the latch member 300 can pass the aligned aperture 118 and first notch 213 and the aligned aperture 118 and second notch 214, respectively, to prevent the flat cable member 200 from being removed from the base portion 110 in the lateral direction X-X.

In an illustrated embodiment, selective contact between the contact face 321a of the snap-slot portion 321 and the snap portions 113, 114 enables the latch member 300 to be switched between the pre-locked position and the locked position. It should be understood by a person skilled in the art that the switching in the embodiments of the present disclosure can be carried out by other suitable ways. For example, in an alternative embodiment, a snap portion can be formed in each of two opposing sides of the two second arms 320 of the latch member 300, and is in the shape of a barb. The snap portion can be selectively snapped into one of two snap slots which are formed in a bottom face of a corresponding one of the first groove 115 and the second groove 116 of the base portion 110 and which are spaced from each other in the vertical direction Z-Z. The two snap slots are positioned substantially corresponding to the snap portions 113, 114 of FIGS. 8A, 8B and 8C, to similarly define the pre-locked position and the locked position of the latch member 300.

As shown by FIGS. 4 and 8B, the insulative housing 100 may include an accommodation portion 150. The accommodation portion 150 extends from the base portion 110 in the lateral direction X-X and encloses an accommodation space 140. In the insulative housing 100, the first channel 111 is configured to be in communication with the accommodation space 140. The accommodation space 140 is open at an end opposite to the base portion 110. The second segment 220 of the flat cable member 200 is positioned in the accommodation space 140 when the flat cable member 200 is inserted in the base portion 110 in place. With such a configuration, the conductive contacts 203 of the flat cable member 200 can be protected by the accommodation portion 150 from being touched by a user's finger or by a tool, thereby prevent the user from getting electric shock or avoiding a short circuit. Such a configuration can improve the safety and reliability of the electronic system 1 using the electrical connector 10.

For example, a leading edge of the second segment 220 of the connection end 202 of the flat cable member 200 may be indented into the accommodation portion 150 by a certain distance relative to the opening of the accommodation portion 150 in the lateral direction X-X. For example, the distance may be greater than or equal to 1 mm.

The accommodation portion 150 of the insulative housing 100 may be formed by a plurality of walls extending from the base portion 110 in the lateral direction X-X. The plurality of walls may include a first wall 151 and a second wall 152 that are opposite to each other and spaced apart from each other in the vertical direction Z-Z, and a third wall 153 and a fourth wall 154 that are opposite to each other and spaced apart from each other in the longitudinal direction Y-Y. The first wall 151, the second wall 152, the third wall 153, and the fourth wall 154 enclose the accommodation space 140. Furthermore, the accommodation portion 150 may be used as a plug-in portion of the insulative housing 100 for insertion into a housing of another electrical connector (e.g., the electrical connector 20 to be described below) that mates with the electrical connector 10.

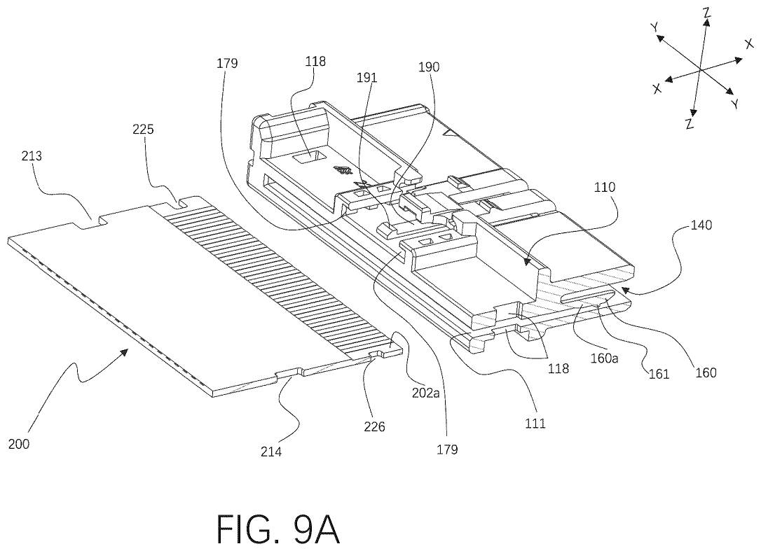

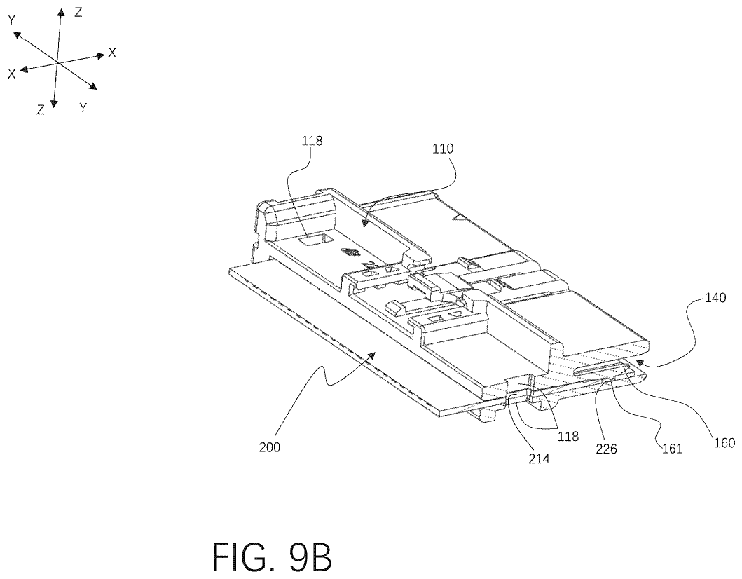

As shown by FIGS. 9A and 9B, the insulative housing 100 may include a third arm 160 extending into the accommodation space 140 from the base portion 110 in the lateral direction X-X. The third arm 160 may include a snap portion 161. The third arm 160 may be a flexible arm. When the flat cable member 200 is disposed in or received by the insulative housing 100 in place, the snap portion 161 of the third arm 160 can engage with a location port of the second segment 220 of the flat cable member 200, to hold the second segment 220 in the accommodation space 140.

As shown by FIGS. 3 and 5, the second segment 220 of the flat cable member 200 includes a first side edge 221 and a second side edge 222 opposite to each other in the longitudinal direction Y-Y. The second segment 220 of the flat cable member 200 may include a first notch 225 recessed into the second segment 220 from the first side edge 221 in the longitudinal direction Y-Y, and a second notch 226 recessed into the second segment 220 from the second side edge 222 in the longitudinal direction Y-Y. Therefore, in the illustrated embodiment, the location port of the second segment 220 can be embodied as the first notch 225 and the second notch 226. The third arm 160 can comprise two third arms 160 respectively. The two third arms 160 are positioned in the longitudinal direction Y-Y corresponding to the first notch 225 and the second notch 226, respectively, such that when the flat cable member 200 in a state as shown by FIG. 9A is inserted in the insulative housing 100 in place (as shown by FIG. 9B), the snap portions 161 of the two third arms 160 (only the snap portion 161 corresponding to the second notch 226 being shown by FIGS. 9A and 9B) can be in engagement with the first notch 225 and the second notch 226 respectively, and the third arms 160 further facilitate locking the flat cable member 200. In an alternative embodiment not shown here, the number of the third arms 160 can be increased or decreased, and the number of the notches of the second segment 220 for engagement with the third arms can be correspondingly increased or decreased. The location port can be embodied as any other suitable form other than the notches 225 and 226. For example, the location port can be embodied as a through hole which is formed in the connection end of the flat cable member 200 away from the respective side edge; and the third arm 160 can be provided in the base portion 110 to enable the snap portion 161 of the third arm to engage with the location port.

When the electrical connector 10 is mated with the electrical connector 20, the design of the third arm 160 can prevent the second segment 220 of the flat cable member 200 from shifting or buckling, thereby increasing the operation reliability of the electronic system 1 comprised of the electrical connector 10 and the electrical connector 20.

As shown by FIG. 9A, each third arm 160 may include a third body 160a. The snap portion 161 protrudes from the third body 160a in the vertical direction Z-Z. The first wall 151 of the accommodation portion 150 and the third bodies 160a of the third arms 160 can clamp the second segment 220 of the flat cable member 200 therebetween. With such a configuration, it is possible to guide the insertion of the second segment 220 of the flat cable member 200 into the accommodation space 140. Furthermore, the second segment 220 of the flat cable member 200 can be reliably held in the accommodation space 140.

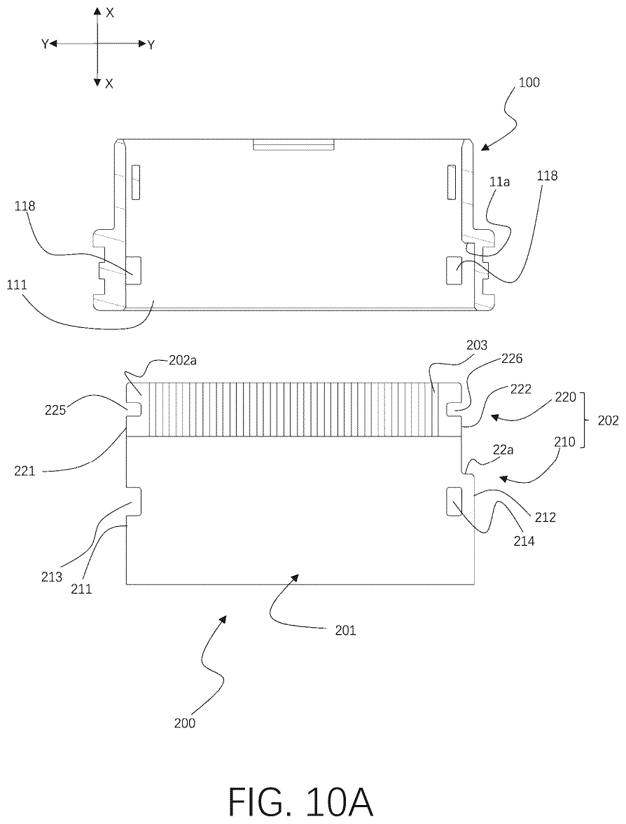

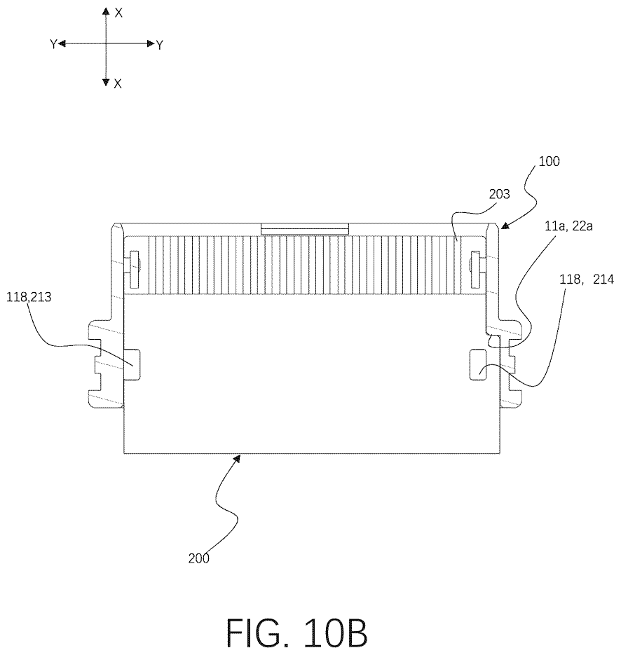

In some embodiments of the present disclosure, as shown by FIGS. 10A and 10B, the first side edge 211 of the first segment 210 and the first side edge 221 of the second segment 220 of the flat cable member 200 defines a first outer profile of the connection end 202 of the flat cable member 200, and the second side edge 212 of the first segment 210 and the second side edge 222 of the second segment 220 of the flat cable member 200 defines a second outer profile of the connection end 202 of the flat cable member 200. The first outer profile is opposite to the second outer profile in the longitudinal direction Y-Y. In some embodiments of the present disclosure, viewed in a projection plane parallel to both of the longitudinal direction Y-Y and the lateral direction X-X, the first and second outer profiles of the flat cable member 200 are non-mirror symmetric relative to each other. For example, a step 22a is formed in the second outer profile defined by the second side edges 212 and 222. In the first channel 111 of the insulative housing 100, a step 11a which is complementary to the step 22a is formed. In this way, when the connection end 202 of the flat cable member 200 is inserted in the insulative housing 100 in place through the first channel 111, the steps 11a and 22a can be in contact with each other. Such a configuration can provide a fool-proof function to ensure that the flat cable member 200 can be inserted in the insulative housing 100 in place in such a way that the first surface 202a of the connection end 202 thereof faces towards the first wall 151 of the accommodation portion 150, and to prevent the flat cable member 200 from being inserted in the insulative housing 100 in an improper orientation (in which improper orientation the conductive contacts 203 of the flat cable member 200 face towards the second wall 152).

As shown by FIG. 4, the first wall 151 and the third wall 153 of the insulative housing 100 are connected to each other at a first corner, the first wall 151 and the fourth wall 154 are connected to each other at a second corner, the second wall 152 and the third wall 153 are connected to each other at a third corner, and the second wall 152 and the fourth wall 154 are connected to each other at a fourth corner.

In some embodiments of the present disclosure, the accommodation portion 150 of the insulative housing 100 may include a first rib 171 protruding outward from the first wall 151 at the first corner in the vertical direction Z-Z, and a second rib 172 protruding outward from the first wall 151 at the second corner in the vertical direction Z-Z. The first rib 171 and the second rib 172 extend in the lateral direction X-X, respectively. As will be described in detail below, the first rib 171 and the second rib 172 are configured to cooperate with corresponding grooves of the housing of the electrical connector 20 when the accommodation portion 150 of the insulative housing 100 is inserted into the housing of the electrical connector 20, so as to guide the insertion of the insertion portion. Such a configuration can prevent the electrical connector 10 from being inserted into the housing of the electrical connector 20 in a skewed orientation, thereby providing protection to the mating conductive structures of the electrical connector 10 and the electrical connector 20, and improving the hot-plugging ability of the electrical connector 10. Alternatively or additionally, the insulative housing 100 may include ribs at the third corner and the fourth corner.

Although in the illustrated embodiments the first wall 151, the second wall 152, the third wall 153 and the fourth wall 154 of the insulative housing 100 are flush with each other at their respective free ends, in a not-shown alternative embodiment the third wall 153 of the insulative housing 100 may extend beyond the first wall 151 and the second wall 152 in the lateral direction X-X to form a first protrusion and the fourth wall 154 may extend beyond the first wall 151 and the second wall 152 in the lateral direction X-X to form a second protrusion. The first protrusion and the second protrusion are configured to mate with corresponding recesses of the housing of the electrical connector 20 when the accommodation portion 150 of the insulative housing 100 is inserted into the housing of the electrical connector 20. Such a configuration can increase the size of the accommodation portion 150 in the mating direction without increasing the overall width of the electrical connector 10 and the electrical connector 20. When the accommodation portion 150 of the electrical connector 10 is inserted into the housing of the electrical connector 20, such a configuration can guide the accommodation portion 150 in the proper orientation and reduce the amount of wobble thereof, thereby increasing the hot-plugging ability of the electrical connector 10. Furthermore, if the accommodation portion 150 of the electrical connector 10 is inserted into the housing of the electrical connector 20 in a skewed orientation, such a configuration can prevent the conductive portions of the electrical connector 10 and the electrical connector 20 from contacting each other to protect the circuit from damage. This can improve the hot-plugging ability and reliability of the electrical connector 10.

In some embodiments of the present disclosure, the electrical connector 10 may include a connector position assurance (CPA) device configured to lock the electrical connector 10 to a mating electrical connector (e.g., electrical connector 20) when the electrical connector 10 is mated with the mating electrical connector.

As shown by FIGS. 4 and 8B, the accommodation portion 150 may include a groove 178 that is recessed into the first wall 151 from the outer surface 151a of the first wall 151 in the vertical direction Z-Z and extends in the lateral direction X-X. The groove 178 may extend to the base portion 110 in the lateral direction X-X.

Further as shown by FIGS. 2, 4 and 8B, the CPA device may include an overhanging structure 180. The overhanging structure 180 may be an integral portion of the accommodation portion 150. The overhanging structure 180 may include a first resilient beam 181 and a second resilient beam 182. The first resilient beam 181 and the second resilient beam 182 extend from a bottom wall 178c of the groove 178 towards the base portion 110 in the lateral direction X-X, respectively. The first resilient beam 181 and the second resilient beam 182 may be cantilever beams. The first resilient beam 181 includes a first end 181a and a second end 181b opposite to each other in the lateral direction X-X. The first end 181a is configured to be fixed and connected to the bottom wall 178c. The second end 181b is configured to be unfixed and spaced apart from the bottom wall 178c in the vertical direction Z-Z. The second resilient beam 182 includes a first end 182a and a second end 182b opposite to each other in the lateral direction X-X. The first end 182a is configured to be fixed and connected to the bottom wall 178c. The second end 182b is configured to be non-fixed and spaced apart from the bottom wall 178c in the vertical direction Z-Z. The first resilient beam 181 and the second resilient beam 182 are spaced apart from each other in the longitudinal direction Y-Y and define a receiving space therebetween. The first resilient beam 181 and the second resilient beam 182 may be parallel to each other.

The overhanging structure 180 may further include a third beam 183. The third beam 183 extends from the second end 181b of the first resilient beam 181 to the second end 182b of the second resilient beam 182 in the longitudinal direction Y-Y. For example, the third beam 183 connects the second end 181b of the first resilient beam 181 to the second end 182b of the second resilient beam 182.

As shown by FIGS. 2 and 8B, a lock boss 184 is formed in the first resilient beam 181 of the overhanging structure 180. The lock boss 184 locates between the first end 181a and the second end 181b of the first resilient beam 181 and protrudes from an exposed surface of the first resilient beam 181. Similarly, a lock boss 184 is also formed in the second resilient beam 182 of the overhanging structure 180. The lock boss 184 locates between the first end 182a and the second end 182b of the second resilient beam 182 and protrudes from an exposed surface of the second resilient beam 182. The two lock bosses 184 are configured to engage with lock holes (explained below) of a mating electrical connector when the electrical connector 10 is mated with the mating electrical connector (for example, the electrical connector 20), to ensure that a sufficient retention force can be exerted between the electrical connector 10 and the mating electrical connector when the latch member 400 is not installed onto the electrical connector 10.

In some embodiments of the present disclosure, as shown by FIGS. 2, 3, and 4, the CPA device may further include the latch member 400. The latch member 400 may be configured to lock the CPA device or the overhanging structure 180 thereof when the electrical connector 10 is mated with the mating electrical connector (for example, the electrical connector 20), to prevent the two electrical connectors from being separated from each other inadvertently.

As shown by FIGS. 1, 8A, and 9A, a pair of receiving slide grooves 179 are formed in the base portion 110 of the insulative housing 100 of the electrical connector 10. For example, the pair of receiving slide grooves 179 are spaced from each other in the longitudinal direction Y-Y and opened to each other, such that the pair of receiving slide grooves 179 can be used to receive the latch member 400. Therefore, the latch member 400 is slidable relative to the base portion 110 in the lateral direction X-X. A guide tongue portion 190 extends from the accommodation portion 150 of the insulative housing 100, for example from the accommodation space 140 thereof. The guide tongue portion 190 is formed such that it at least partially extends between the pair of receiving slide grooves 179, and a limitation protrusion 191 is formed at a free end of the guide tongue portion 190 (away from the accommodation portion). The guide tongue portion 190 and the slide grooves 179 are parallel to each other and extend in the lateral direction X-X.

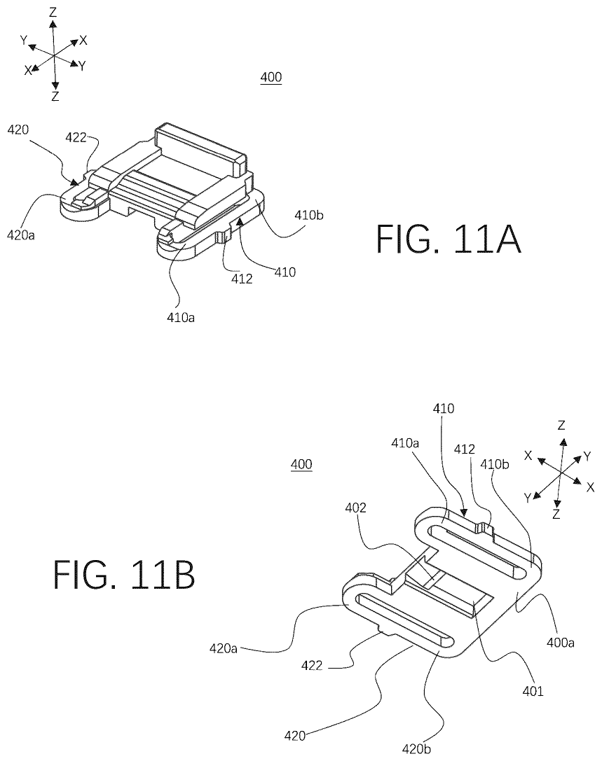

As shown by FIGS. 11A and 11B, a guide slot 401 is formed in a first side 400a of the latch member 400. The first side 400a is a side of the latch member 400 which faces towards the base portion 110 when the latch member is received by the receiving slide grooves 179. Moreover, the guide slot 401 is configured to receive the guide tongue portion 190 when the latch member 400 are received by the receiving slide grooves 179. For example, the guide tongue portion 190 is guided in the guide slot 401 as the latch member 400 is slid relative to the base portion 110. Therefore, sliding of the latch member 400 relative to the base portion 110 is guided not only by the receiving slide grooves 179 but also by the guide tongue portion 190, resulting in improved sliding stability thereof. A stop 402 is formed at an end of the guide slot 401, such that when the guide slot 401 is used to receive the guide tongue portion 190, the maximum travel of the latch member 400 moving away from the accommodation portion 150 in the lateral direction is restricted by the stop 402 contacting the limitation protrusion 191 of the guide tongue portion 190.

As shown by FIGS. 11A and 11B, the latch member 400 may include a base body and a first resilient arm 410 and a second resilient arm 420 extending from the base body in the lateral direction X-X, respectively. The base body may be shaped to facilitate engagement by a user's hand to move the latch member 400 in the receiving slide grooves 179. The first resilient arm 410 and the second resilient arm 420 are opposite to each other in the longitudinal direction Y-Y. Furthermore, the first resilient arm 410 comprises a first end 410a and a second end 410b which are opposite to each other in the lateral direction X-X. The first resilient arm 410 is configured to be connected to the base body of the latch member 400 via the first end 410a and the second end 410b only. The first resilient arm 410 includes a first intermediate portion between the first end 410a and the second end 410b, and the first intermediate portion is separated from the base body of the latch member 400 in the longitudinal direction Y-Y. Similarly, the second resilient arm 420 comprises a first end 420a and a second end 420b which are opposite to each other in the lateral direction X-X. The second resilient arm 420 is configured to be connected to the base body of the latch member 400 via the first end 420a and the second end 420b. The second resilient arm 420 includes a second intermediate portion between the first end 420a and the second end 420b, and the second intermediate portion is separated from the base body of the latch member 400 in the longitudinal direction Y-Y.

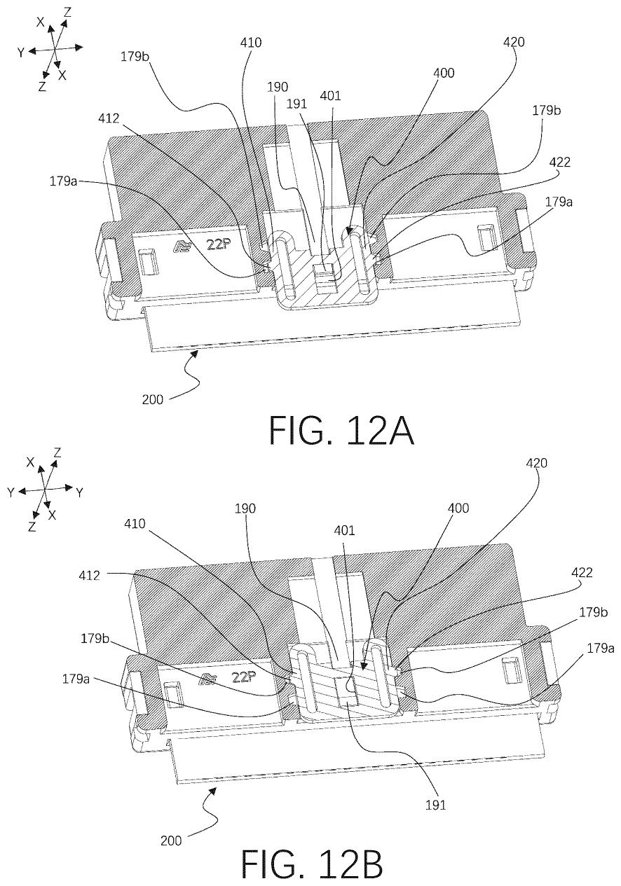

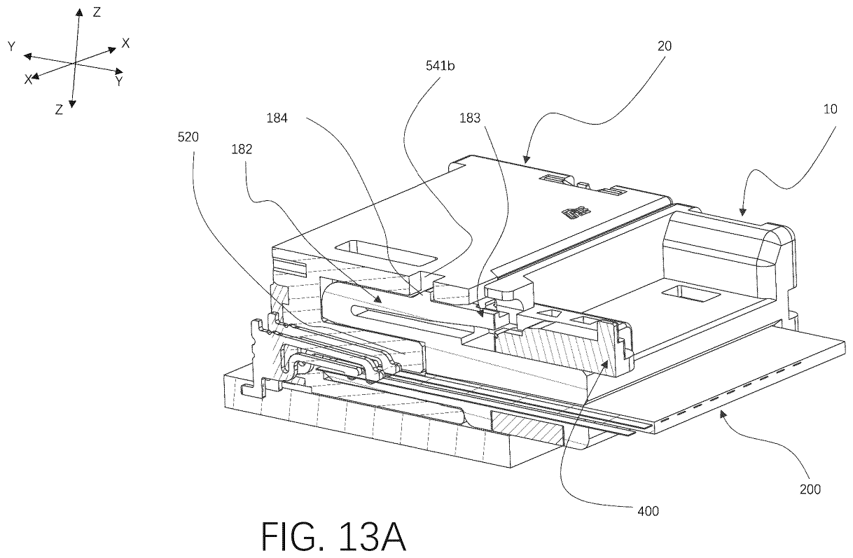

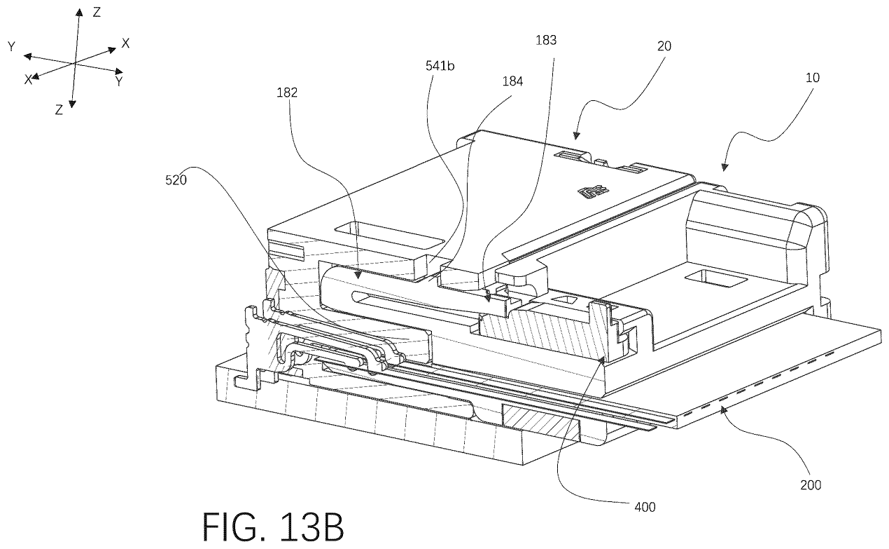

The latch member 400 is configured such that the first resilient arm 410 and the second resilient arm 420 thereof are received by the receiving slide grooves 179 respectively. A first protrusion 412 is formed between the first end 410a and the second end 410b of the first resilient arm 410, and a second protrusion 422 is formed between the first end 420a and the second end 420b of the second resilient arm 420. The first protrusion 412 and the second protrusion 422 are formed such that they protrude oppositely in the longitudinal direction Y-Y. Furthermore, two recesses 179a, 179b are formed in each receiving slide groove 179 and spaced from each other in the lateral direction X-X, such that when the first resilient arm 410 and the second resilient arm 420 are received by the receiving slide grooves 179 respectively, the first protrusion 412 of the first resilient arm 410 and the second protrusion 422 of the second resilient arm 420 can be selectively received by the two recesses 179a, 179b of each respective receiving slide groove 179 respectively. With such a configuration, the latch member 400 can be selectively placed in a pre-locked position (a first position shown by FIG. 12A) and a locked position (a second position shown by FIG. 12B). In the pre-locked position (as shown by FIG. 13A), the latch member 400 is reliably held on the insulative housing 100 and the overhanging structure 180 is unlocked to allow the first resilient beam 181, the second resilient beam 182, and the third beam 183 of the overhanging structure 180 to move towards the bottom wall 178c when biased towards the bottom wall 178c. In the locked position (as shown by FIG. 13B), the latch member 400 is also reliably held on the insulative housing 100 and the overhanging structure 180 is locked to prevent the first resilient beam 181, the second resilient beam 182, and the third beam 183 from moving towards the bottom wall 178c when biased towards the bottom wall 178c. Such a configuration can enable the electrical connector 10 to meet the requirements of a specification such as USCAR. As the latch member 400 can be pre-locked into position, loss of the latch member 400 can be avoided when the electrical connector 10 is mated with the mating connector, and the assembly efficiency of the electronic system 1 can be improved.

Furthermore, according to some embodiments of the present disclosure, the latch member 400 is configured such that only when it is in the pre-locked position, both of the first protrusion 412 and the second protrusion 422 of the latch member 400 can be locked in the recesses 179a, 179b and the limitation protrusion 191 of the receiving slide groove 179 is in contact with the stop 402 to ensure that the latch member 400 is prevented from being escaped out of the CPA device due to unexpected forces, resulting in improved reliability.

A concrete process to operate the overhanging structure 180 and the latch member 400 to lock the electrical connector 10 to the electrical connector 20 or unlock the former from the latter will be explained below in combination with examples of a connector assembly comprised of the electrical connector 10 and the electrical connector 20.

Although in the embodiments already explained here the electrical connector 10 is provided with a single flat cable member, it should be understood that the present disclosure is not limited to the single flat cable member case. In alternative embodiments, the electrical connector 10 may comprise more (for example, two, three, four, five) flat cable members. Correspondingly, the configuration of the insulative housing 100 can be modified to container more flat cable members. For example, the insulative housing 100 may have more first channels 111.

Although in the embodiments already explained here the latch member 300 has two first arms 310, it should be understood that the present disclosure is not limited by this. In alternative embodiments, the latch member 300 may have a single first arm 310 or may have more than two first arms 310. The number of second channels of the insulative housing 100 and the number of the notches of the flat cable members can be correspondingly modified. For example, the flat cable member can be provided with a plurality of notches at each side edge, or alternatively the flat cable member can be provided with one or more notches at a single side edge only.

Although in the embodiments already explained here the latch member 300 has two second arms 320, it should be understood that the present disclosure is not limited by this. In alternative embodiments, the latch member 300 may have a single second arm 320. For example, the latch member 300 may comprise a single first arm 310 and a single second arm 320 to accomplish the already explained pre-locking and locking functions. In alternative embodiments, the latch member 300 may comprise more than two second arms 320. The number of grooves of the insulative housing 100 for receiving the second arms can be modified correspondingly.

### Receptacle Connector

As shown by FIGS. 14A and 14B, the electrical connector 20 may include an insulative housing 500 and a plurality of conductive terminals 600. The insulative housing 500 can be secured to a printed circuit board 30 via hold-down tabs 700.

The plurality of conductive terminals 600 are disposed in the insulative housing 500. The insulative housing 500 provides support and protection to the plurality of conductive terminals 600. The insulative housing 500 may be formed from an insulative material. Examples of insulative materials suitable for forming the insulative housing 500 include, but are not limited to, plastic, nylon, liquid crystal polymer (LCP), polyphenylene sulfide (PPS), high temperature nylon or polyphenylene oxide (PPO) or polypropylene (PP).

The electrical connector 20 may be configured to be disposed on the surface 31 of the circuit board 30 (as shown by FIG. 1) and electrically connected to the conductive structures (e.g., the conductive pads on the surface 31 but being hidden in FIG. 1) of the circuit board 30. The insulative housing 500 may be configured to be placed on the surface 31 of the circuit board 30. The insulative housing 500 may include slots 530 for receiving hold-down tabs 700. As shown by FIGS. 1 and 14A, the hold-down tabs 700 may be inserted into the corresponding slots 530 and secure the insulative housing 500 on the circuit board 30. The hold-down tabs 700 may be formed from a metallic material.

As shown by FIGS. 14A and 14B, the insulative housing 500 may include a base portion 510 and a tongue portion 520 extending from the base portion 510 in the lateral direction X-X. The tongue portion 520 extends from a first surface (front surface) 511 of the base portion 510 in the lateral direction X-X. The tongue portion 520 may include a first surface 521 and a second surface 522 opposite to each other in the vertical direction Z-Z perpendicular to the lateral direction X-X. The base portion 510 may include a top surface 515 and a bottom surface 516 opposite to each other in the vertical direction Z-Z. When the electrical connector 20 is installed on the circuit board 30, the bottom surface 516 of the base portion 510 faces towards the surface 31 of the circuit board, and the second surface 522 of the tongue portion 520 is closer to the surface 31 of the circuit board 30 and the bottom surface 516 of the base portion 510 in the vertical direction Z-Z than the first surface 521.

The conductive terminal 600 may be formed from a conductive material. The conductive material suitable for forming the conductive terminal 600 may be a metallic material, such as a copper alloy. The conductive terminal may also be referred to as “a terminal”, “a conductor”, or “a conductive element”.

Each conductive terminal 600 includes a mating end having a mating contact portion, a contact tail opposite to the mating end, and an intermediate portion joining the mating end and the contact tail. The plurality of conductive terminals 600 are configured similarly and arranged in the insulative housing 500 such that they are spaced from each other in the longitudinal direction Y-Y.

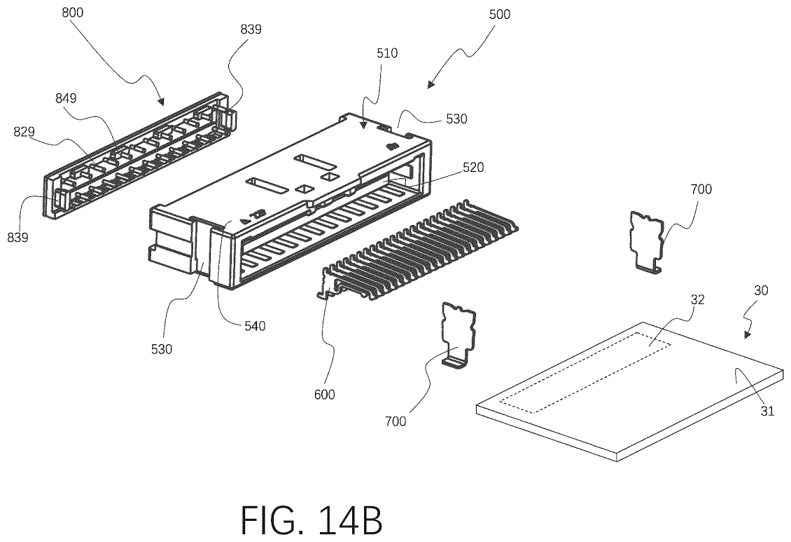

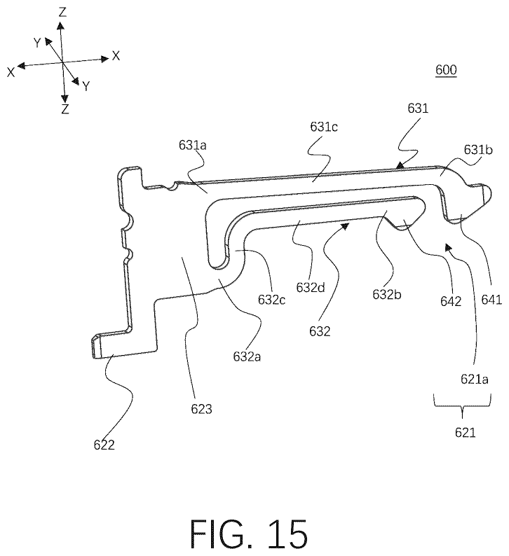

As shown by FIG. 15, each conductive terminal 600 includes a mating end 621 having a mating contact portion 621a, a contact tail 622 opposite to the mating end 621, and an intermediate portion 623 joining the mating end 621 and the contact tail 622.

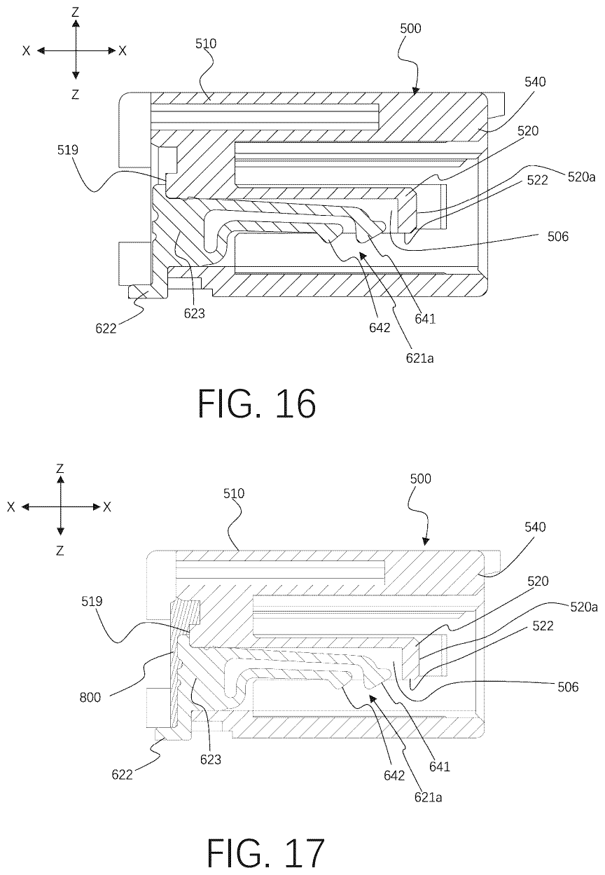

The insulative housing 500 may include a plurality of channels 506 extending from the base portion 510 into the tongue portion 520 in the lateral direction X-X. One of the channels 506 is shown by FIG. 16. The plurality of channels 506 are spaced from each other in the longitudinal direction Y-Y.

As shown by FIG. 16, each channel 506 may extend into the tongue portion 520 from a first side 519 of the base portion 510 opposite to the tongue portion 520 in the lateral direction X-X and is open at the second surface 522 of the tongue portion 520. The intermediate portion 623 and the mating end 621 of each of the plurality of conductive terminals 600 are inserted into the corresponding channel 506 from the first side 519 of the base portion 510, the intermediate portion 623 is disposed in the base portion 510, and the mating end 621 extends into the tongue portion 520 with the mating contact portion 621a protruding from the first surface 521. With such a configuration, as will be described in detail below, when the electrical connector 10 is mated with the electrical connector 20, the mating contact portions 621a of the plurality of conductive terminals 610 can establish a separable electrical contact with the plurality of conductive contacts 203 of the flat cable member 200 of the electrical connector 10.

As shown by FIGS. 15 and 16, each conductive terminal 600 can have a double-beam double-contact configuration. Specifically, the mating end 621 of the conductive terminal 600 is configured such that the mating end 621 of the conductive terminal 600 may include a first beam 631 and a second beam 632. The first beam 631 and the second beam 632 extend from the intermediate portion 613 in the lateral direction X-X in a plane substantially perpendicular to the longitudinal direction Y-Y. The first beam 631 and the second beam 632 are spaced from each other.

As shown by FIG. 15, the first beam 631 of each conductive terminal 600 includes a first end 631a and a second end 631b opposite to each other, and a first straight segment 631c joining the first end 631a and the second end 631b. The first end 631a is connected to the intermediate portion 623, and the second end 631b is configured to be unfixed. For example, the first beam 631 is a cantilever beam. The first straight segment 631c extends from the first end 631a obliquely relative to or parallel to the lateral direction X-X towards the second beam 632 to the second end 631b. A first contact portion 641 of the first beam 631 is located at the second end 631b and protrudes from the first straight segment 631c in the vertical direction Z-Z.

The second beam 632 of each conductive terminal 600 includes a third end 632a and a fourth end 632b opposite to each other, a curved segment 632c extending from the third end 632a, and a second straight segment 632d joining the curved segment 632c and the fourth end 632b. The third end 632a is connected to the intermediate portion 613, and the fourth end 632b is configured to be unfixed. For example, the second beam 632 is a cantilever beam. The curved segment 632c of the second beam 632 is curved from the third end 632a towards the first beam 631 so that the second straight segment 632d and the fourth end 632b are located between the intermediate portion 623 of the conductive terminal 600 and the second end 631b of the first beam 631 in the lateral direction X-X. The second straight segment 632d extends from the curved segment 632c to the fourth end 632b. A second contact portion 642 is located at the fourth end 632b and protrudes from the second straight segment 632d in the vertical direction Z-Z. With such a configuration, the first beam 631 can prevent the second beam 632 from excessive deformation to protect the second beam 632, when the second beam 632 is biased to deflect towards the first beam 631 in the vertical direction Z-Z. Further, the shapes of the first beam 631 and the second beam 632 of the first conductive terminal 610 can provide a longer force arm in a limited space, thereby improving the consistency of the contact forces provided by the first beam 631 and the second beam 632.

The first contact portion 641 and the second contact portion 642 together defines the mating contact portion 621a of the mating end 621 to form a double-contact configuration. The double-contact configuration of the conductive terminal 600 can provide more contact locations in a limited space, thus enabling the electrical connector 20 to meet high pin count requirements.

It should be appreciated that the specific configuration of the mating portion of the conductive terminal 600 is not limited to the configuration described above. In some other embodiments, the mating end 621 of the conductive terminal 610 may have a single beam and a single contact, or have more beams and more contacts.

As shown by FIG. 16, after each conductive terminal 600 is inserted in the channel 506, the mating end 621 and one part of the intermediate portion 623 of the conductive terminal 600 is in the base portion 510, and the other part of the intermediate portion 623 and the contact tail 622 of the conductive terminal 600 are exposed from or adjacent to the first side 519 of the base portion 510 such that the contact tail 622 can establish an electrical connection with a corresponding conductive structure of the circuit board 30.

As shown by FIG. 14A, the insulative housing 500 further includes an accommodation portion 540 extending from a first surface 511 of the base portion 510 in the lateral direction X-X and enclosing an accommodation space 550. The accommodation portion 540 is opposite to the base portion 510 in the lateral direction X-X. The tongue portion 520 is positioned in the accommodation space 550. The accommodation space 550 is open at an end opposite to the base portion 510. With such a configuration, the mating end 621 of the conductive terminal 600 can be positioned in the accommodation space 550 and protected by the accommodation portion 540 from being touched by a user's finger or by a tool, thereby preventing the user from getting electric shock or avoiding a circuit short. Such a configuration can improve the safety and reliability of the electronic system 1 utilizing the electrical connector 20.

For example, a front end 520a of the tongue portion 520 may be indented into the accommodation space 550 by a given distance in the lateral direction X-X relative to an opening of the accommodation space 550 defined by the accommodation portion 540. The distance may be, for example, greater than or equal to 1 mm.

The accommodation portion 540 of the insulative housing 500 may include a first wall 541 and a second wall 542 opposite to each other and spaced apart from each other in the vertical direction Z-Z, and a third wall 543 and a fourth wall 544 opposite to each other and spaced apart from each other in the longitudinal direction Y-Y. The first wall 541, the second wall 542, the third wall 543, and the fourth wall 544 enclose the accommodation space 550. The accommodation space 550 may be used as a slot of the insulative housing 500 to receive a housing of another electrical connector that mates with the electrical connector 20. For example, the accommodation space 550 may receive the accommodation portion 150 of the insulative housing 100 of the electrical connector 10.

As shown by FIG. 14A, the first wall 541 and the third wall 543 of the insulative housing 500 are connected to each other at a first corner, the first wall 541 and the fourth wall 544 are connected to each other at a second corner, the second wall 542 and the third wall 543 are connected to each other at a third corner, and the second wall 542 and the fourth wall 544 are connected to each other at a fourth corner.

According to some embodiments of the present disclosure, the accommodation portion 540 of the insulative housing 500 may include a first groove 561 recessed into the first wall 541 from the accommodation space 550 in the vertical direction Z-Z at the first corner, and a second groove 562 recessed into the first wall 541 from the accommodation space 550 in the vertical direction Z-Z at the second corner. The first groove 561 and the second groove 562 extend in the lateral direction X-X, respectively. The first groove 561 and the second groove 562 are configured to receive the first rib 171 and the second rib 172 of the insulative housing 100 of the electrical connector 10, respectively. With such a configuration, only when the first rib 171 and the second rib 172 of the insulative housing 100 are aligned with the first groove 561 and the second groove 562 in the lateral direction X-X, respectively, the accommodation portion 150 of the insulative housing 100 of the electrical connector 10 can be inserted into the accommodation space 550 of the accommodation portion 540 of the insulative housing 500 of the electrical connector 20. Additionally, a third groove 563 and a fourth groove 564 are also formed in the first wall 541, to receive the first resilient beam 181 and the second resilient beam 182 of the overhanging structure 180 respectively. According to some embodiments of the present disclosure, the first groove 561, the second groove 562, the third groove 563, and the fourth groove 564 are formed in only the first wall 541 facing towards the first surface 521 of the tongue portion 520; and similar grooves are not formed in the second wall 542 facing towards the opposing second surface 522 of the tongue portion 520. Such an asymmetrical configuration can prevent the electrical connector 10 from being inserted into the electrical connector 20 in a skewed orientation, thereby providing protection to the mating conductive structures of the electrical connector 10 and the electrical connector 20, and improving the hot-plugging ability of the electrical connector 20. Furthermore, during insertion of the accommodation portion 150 into the accommodation space 550 of the accommodation portion 540, the first groove 561, the second groove 562, the third groove 563, and the fourth groove 564 can provide guidance for the insertion. In addition, cooperation of the first rib 171 and the second rib 172 with the first groove 561 and the second groove 562 and cooperation of the first resilient beam 181 and the second resilient beam 182 with the third groove 563 and the fourth groove 564 can ensure the electrical connector 10 to be inserted into the electrical connector 20 in a unique (exclusive) orientation. Alternatively or additionally, the insulative housing 500 may include grooves at the third corner and the fourth corner.

As shown by FIGS. 14A and 14B, the tongue portion 520 may be spaced apart from the third wall 543 and the fourth wall 544 in the lateral direction X-X, respectively, and may be spaced apart from the first wall 541 and the second wall 542 in the vertical direction Z-Z, respectively. When the accommodation portion 150 of the insulative housing 100 of the electrical connector 10 is inserted into the accommodation space 550 of the accommodation portion 540 of the insulative housing 500 of the electrical connector 20, the first wall 151 of the insulative housing 100 is positioned between the tongue portion 520 and the first wall 541, the second wall 152 of the insulative housing 100 and the flat cable member 200 are positioned between the tongue portion 520 and the second wall 542, the third wall 153 of the insulative housing 100 is positioned between the tongue portion 520 and the third wall 543, and the fourth wall 154 of the insulative housing 100 is positioned between the tongue portion 520 and the fourth wall 544.

According to some embodiments of the present disclosure, as shown by FIG. 14B, the electrical connector 20 also includes a seal cover 800. The seal cover 800 is configured to be attached on the first side 519 of the base portion 510, so as to cover a part of the intermediate portion 623 of each conductive terminal 600 otherwise exposed from the first side 519 and the majority part of the contact tail 622. In some embodiments, a portion of the contact tail 622 is embedded in the seal cover 800. The contact tail 622 is left with an uncovered part which is sufficient for being electrically connected to a corresponding conductive structure 32 (for example a conductive pad). As the conductive terminals 600 are inserted in the channels 506 of the insulative housing 500, gaps will inevitably exist between the conductive terminals 600 and the channels 506. However, depending on the assembly process of electrical connectors, electronic systems and printed circuit boards, after an electrical connector is installed onto a printed circuit board, a liquid glue will be applied correspondingly. The applied liquid glue may permeate through the gaps into the channels 506 of the insulative housing 500, thus residing at the contact portions of the conductive terminals 600 (such as the first contact portions 641 and the second contact portions 642), resulting in poor electrical conductivity there and affecting normal operation of the electronic system 1 or the electrical connector 10 or 20. According to some embodiments of the present disclosure, the provision of the seal cover 800 can lead to an increased path length through which the applied liquid glue permeates through the gaps. Moreover, there is an over-molded area caused by secondary die molding between the seal cover 800 itself and a part of the conductive terminals 600 (as explained below), the chance of the liquid glue permeating into the gaps and the channels 506 of the insulative housing 500 is greatly decreased to improve the electrical conductivity of the conductive terminals 600.

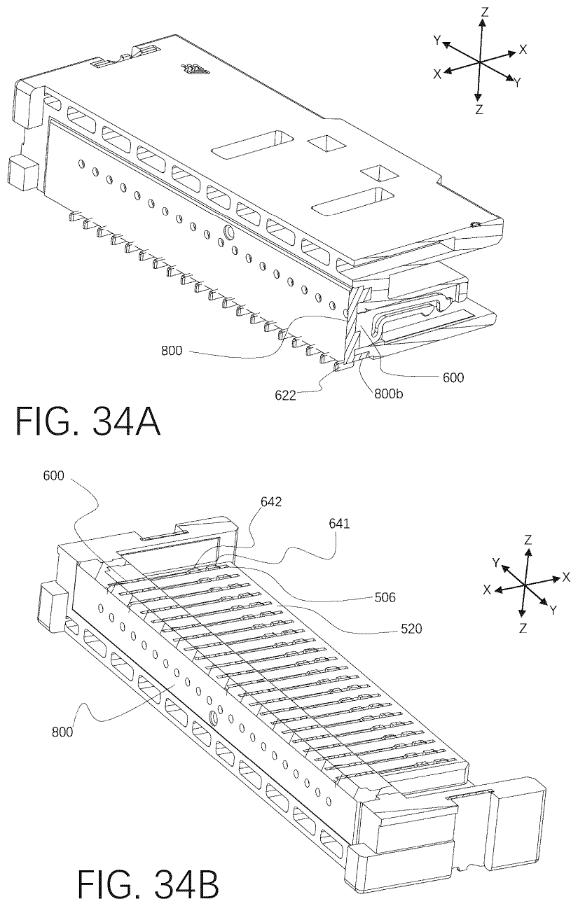

The seal cover 800 can be made of any suitable seal insulative material, such as a plastic material or the like. According to some embodiments of the present disclosure, the seal cover 800 is formed onto the insulative housing 500 by a process of secondary die molding when the conductive terminals 600 have been fitted into the insulative housing 500, especially as shown by FIGS. 34A and 34B. Using the process of secondary die molding, the terminals 600 can be at least partially covered by the seal cover 800. Especially, the intermediate portions 623 and parts of the contact tails 622 of the conductive terminals 600 can be covered by the seal cover 800. In this way, the chance of the liquid glue permeating through the gaps into the channels 506 of the insulative housing 500 is greatly decreased to improve the electrical conductivity of the conductive terminals 600.

A plurality of receiving holes 529, 539, 549 are formed in the first side 519 of the base portion 510 of the insulative housing 500 or a part surrounding the first side 519. For example, the internal shapes of the receiving holes 529, 539, and 549 can be different than each other. However, these holes are configured to secure the seal cover 800. A plurality of pillars 829, 839, and 849, complementary to these receiving holes, are integrally formed in the seal cover 800. These pillars 829, 839, and 849 extend from a side 800a of the seal cover 800 facing towards the base portion 510.

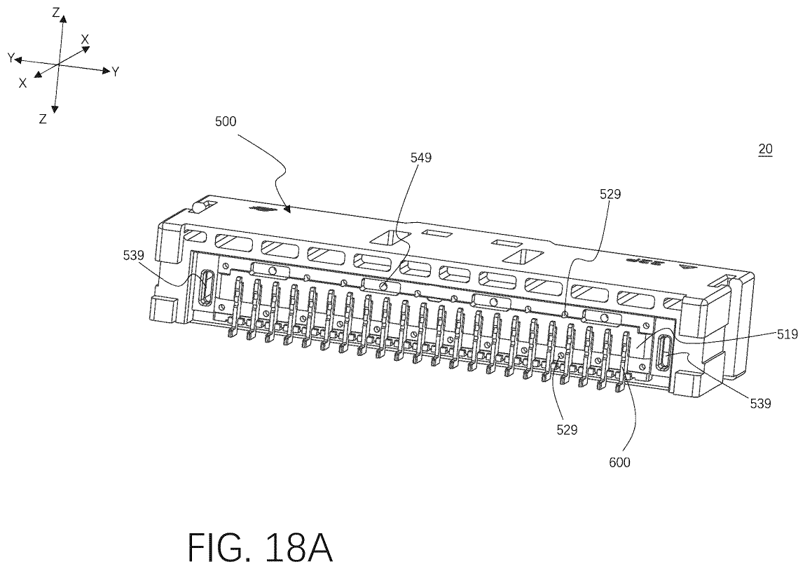

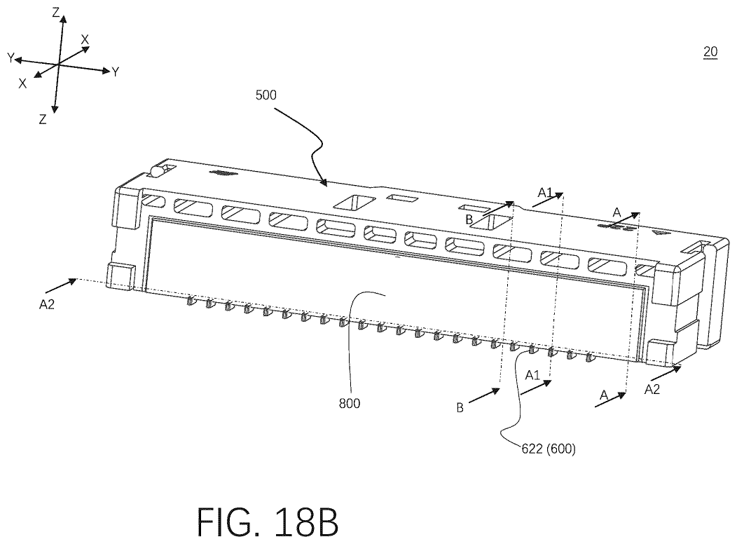

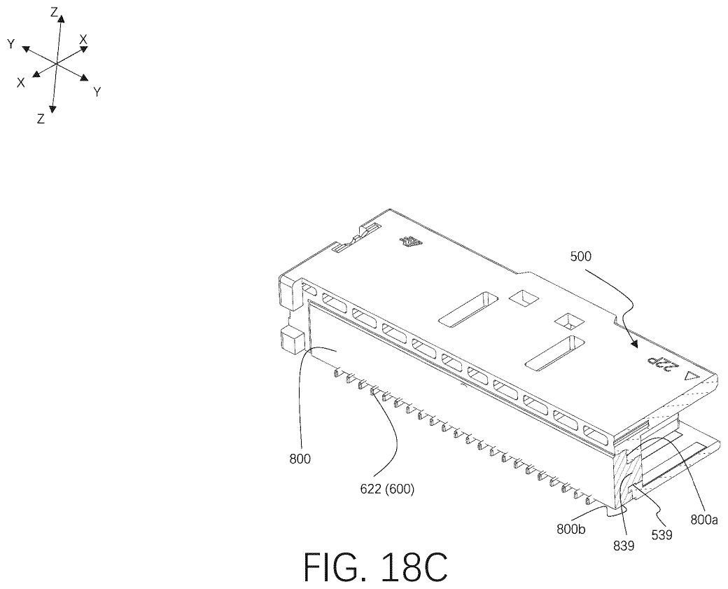

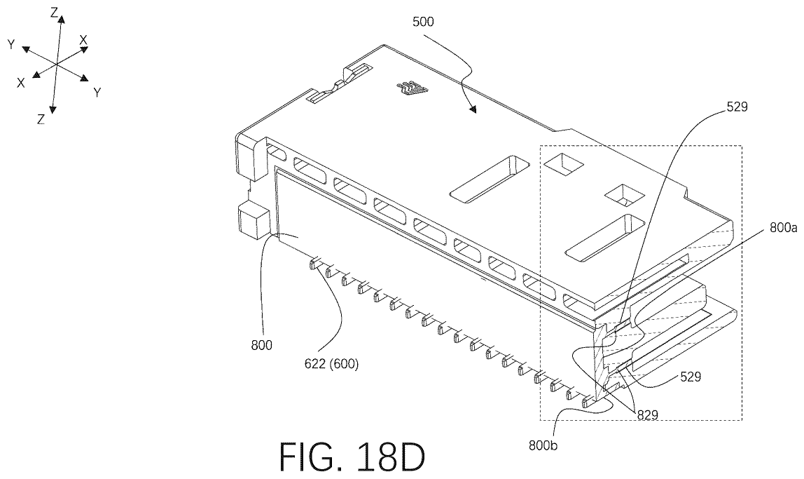

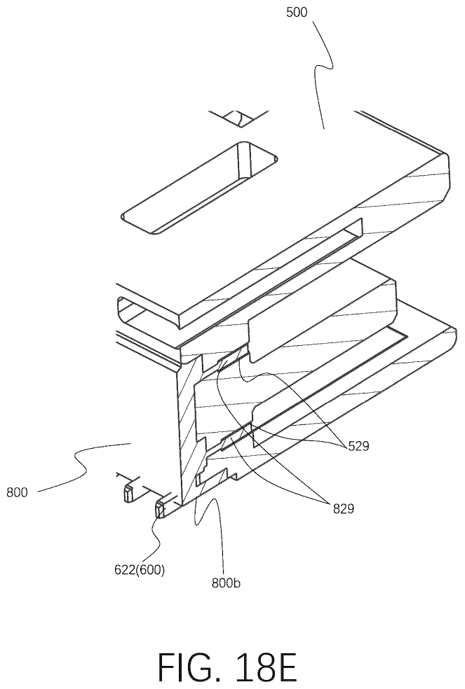

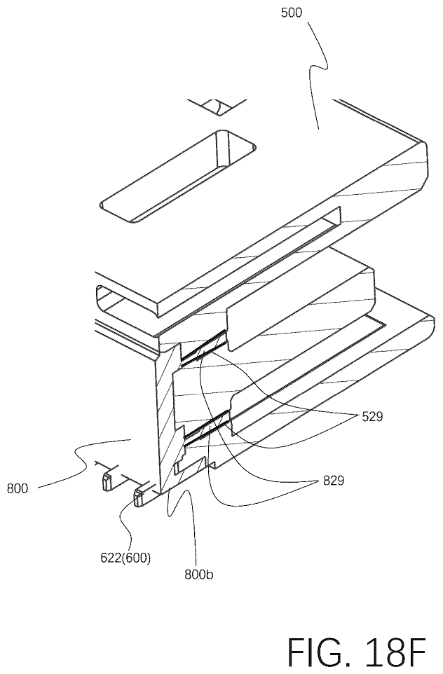

For example, as shown by FIG. 18A, two receiving holes 539 are formed in both ends of the base portion 510 of the insulative housing 500 in the longitudinal direction Y-Y, respectively. The two receiving holes 539 are configured to receive two pillars 839 of the seal cover 800 which are formed substantially in both ends thereof in the longitudinal direction Y-Y respectively. Specifically, the receiving hole 539 is formed with at least two sections (two sections being shown by FIG. 18C), wherein the section of the receiving hole 539 close to the seal cover 800 has a hole diameter less than that of the section of the receiving hole 539 away from the seal cover 800. Therefore, under the process of the secondary die molding, a corresponding pillar 839 is also formed with at least two sections (two sections being shown by FIG. 18C), wherein the section of the pillar 839 close to the side 800a has a diameter less than that of the section of the pillar 839 away from the side 800a. For example, the pillar 839 is formed as an inverted shape. Such an inverted shape can prevent the seal cover 800 from inadvertently escaping out of the insulative housing 500, resulting in improved fixation firmness. It should be understood that such an inverted shape can be adopted in one or two or any number of the pillars of the seal cover 800; correspondingly, a complementary inverted shape can be adopted in one or two or any number of the receiving holes of the base portion 510 of the insulative housing 500.

FIGS. 18D and 18E show that a receiving hole 529 of the base portion 510 receives a pillar 829 of the seal cover 800. For example, the receiving hole 529 is formed with at least two sections (two sections being shown by FIGS. 18D and 18E), wherein the section of the receiving hole 529 close to the seal cover 800 has a hole diameter less than that of the section of the receiving hole 529 away from the seal cover 800. Therefore, under the process of secondary die molding, the pillar 829 is also formed with at least two sections (two sections being shown by FIGS. 18E and 18E), wherein the section of the pillar 829 closed to the side 800a of the seal cover 800 has a diameter less than that of the section of the pillar 829 away from the side 800a of the seal cover 800. For example, the pillar 829 is formed as an inverted shape. Such an inverted shape can prevent the seal cover 800 from inadvertently escaping out of the insulative housing 500, resulting in improved fixation firmness.

It should be understood that the shapes, sizes and positions of the receiving holes in the base portion for the seal cover 800 can be modified depending on requirements. The inverted shapes of the pillars of the seal cover 800 are not limited to the case of FIGS. 18C, 18D, and 18E in which diameters are modified in sections. An alternative embodiment of the inverted shape of the pillar 829 of the seal cover 800 is shown by FIG. 18F, in which the inverted shape of the pillar 829 is formed such that its diameter gradually increases from a location close to the side 800a of the seal cover 800 towards a location away from the side 800a; correspondingly, the receiving hole 529 for receiving the pillar 829 is formed in the base portion 510 such that the hole diameter gradually increases from a location close to the side 800a of the seal cover 800 towards a location away from the side 800a. Such an inverted shape can prevent the seal cover 800 from inadvertently escaping out of the insulative housing 500, resulting in improved fixation firmness.

As shown by FIG. 18C, the seal cover 800 also has a side 800b facing towards the contact tails 622 of the conductive terminals 600. The contact tails 622 of the conductive terminals 600 protrude from the side 800b. When the contact tails 622 of the conductive terminals 600 are welded to the conductive structures 32 (for example the conductive pads) of the circuit board 30, the side 800b faces towards the surface 31 of the circuit board 30, and there might be a gap existing between the side 800b and the surface 31 of the printed circuit board 30. When the printed circuit board 30 is applied with a liquid glue, the applied liquid glue might be sucked into this gap due to a siphon effect generated by the gap, to affect the electrical conductivity of the conductive terminals 600.

According to a preferred embodiment of the present disclosure, in order to solve the issue of excessive permeability of the applied liquid glue, a coating layer can be sprayed onto the side 800b of the seal cover 800 before the contact tails 622 of the conductive terminals 600 are welded to the conductive structures 32 (for example the conductive pads) of the circuit board 30. The coating layer can be made of a suitable high temperature-resistant material such as high temperature-resistant epoxy resin. According to some embodiments, the coating layer can be made of a non-transparent material. In some embodiments, the coating layer encloses portions of the contact tails 622 of the conductive terminals 600. The coating layer has a thickness not affecting the welding of the contact tails 622 to the conductive structures 32 (for example the conductive pads) of the circuit board 30. According to the embodiment of the present disclosure, the existence of the coating layer on the side 800b of the seal cover 800 can greatly reduce a possibility of any gap existing between the side 800b and the surface 31 of the printed circuit board 30, thus eliminating the chance of the applied liquid glue permeating into the gap and resulting in improved conductive reliability of the conductive terminals 600.

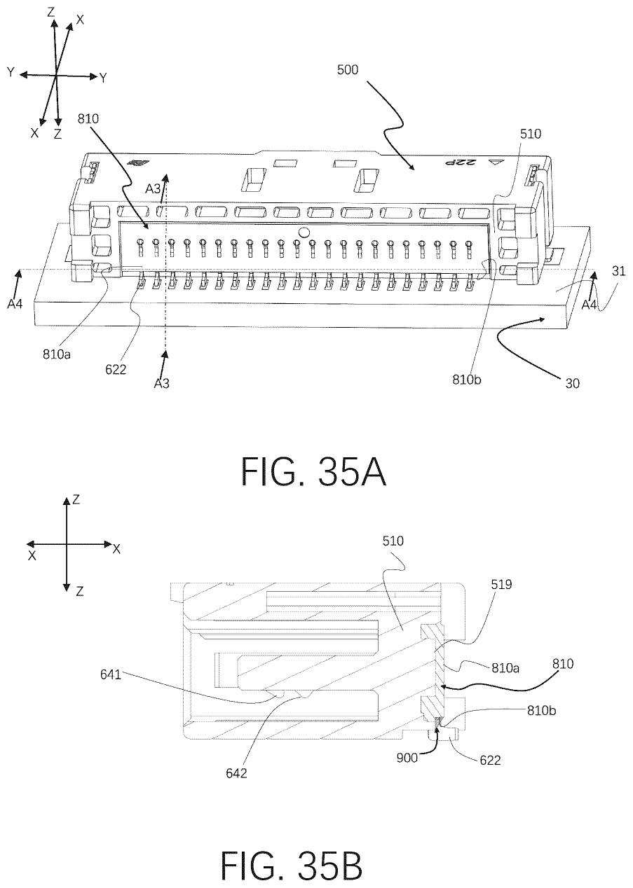

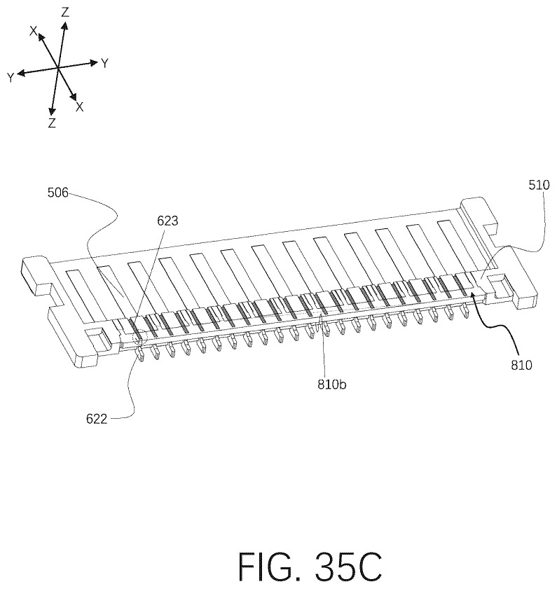

FIGS. 35A to 35C schematically illustrate an electrical connector 20 according to another embodiment of the present disclosure for solving the issue of excessive permeability of a liquid glue applied at a corresponding location of the electrical connector. In the illustrated embodiment, the same reference numerals can refer to the already explained contents and will not be explained again. In the illustrated embodiment, a seal cover 810 is provided on a first side 519 of a base portion 510 of an insulative housing 500 of the electrical connector 20. For example, the seal cover 810 can be configured in a manner similar to the seal cover 800 as explained above. As shown by FIG. 35A, the seal cover 810 has a side 810a away from the first side 519 of the base portion 510 and a side 810b substantially facing towards the surface 31 of the circuit board 30. As shown by FIG. 35B, an impermeable adhesive or coating layer 900 is sprayed between the seal cover 810 and the base portion 510 from a direction of the contact tails 622 of the conductive terminals 600 before the electrical connector 20 is connected to the circuit board 30. For example, the impermeable adhesive or coating layer 900 can be blue in color, and becomes shiny under ultraviolet light. The impermeable adhesive or coating layer 900 is used to prevent a liquid glue, when applied onto the electrical connector 20, from permeating into any gap probably existing between the seal cover 810 and the contact tails 622 of the conductive terminals 600 (for example at a dotted circle schematically shown by FIG. 35C) and affecting electrical conductivity. It should be understood that the contact tails 622 of the conductive terminals 600 are exposed from the side 810b of the seal cover 810, and the impermeable adhesive or coating layer 900 is sprayed in an amount not affecting later connection of the contact tails 622 to the circuit board 30. In an additional embodiment, the impermeable adhesive or coating layer 900 can be also sprayed onto the side 810a of the seal cover 810.

As shown by FIG. 1, two lock holes 541b are formed in the insulative housing 500, especially in the first wall 541 of the accommodation portion 540 of the insulative housing 500. The two lock holes 541b are configured to receive the lock bosses 184 of the first resilient beam 181 and the second resilient beam 182 of the overhanging structure 180, respectively, when the accommodation portion 150 of the electrical connector 10 is suitably inserted in the accommodation space 550 of the accommodation portion 540 of the insulative housing 500. As shown by FIG. 13A, when the latch member 400 is in the pre-locked position, the latch member 400 is not in engagement with the overhanging structure 180 such that the first resilient beam 181, the second resilient beam 182, and the third beam 183 of the overhanging structure 180 can be forced to move relative to the accommodation portion 540. Further as shown by FIG. 13B, when the latch member 400 is in the locked position, a part of the base body of the latch member 400 can extend between the bottom wall 178c of the groove 178 of the accommodation portion 150 and the third beam 183 and/or the first resilient beam 181, the second resilient beam 182, such that the first resilient beam 181, the second resilient beam 182, and the third beam 183 cannot be moved relative to the accommodation portion 540 and thus the accommodation portions 540 and 150 are securely locked together.

Although the intermediate portions and the mating ends of the conductive terminals 600 are described here to be directly inserted into the channels of the insulative housing 500, it should be understood that the present disclosure is not limited to this. In some other embodiments, the insulative housing 500 can be molded surround the intermediate portions and the mating ends of the conductive terminals 600 or alternatively the conductive terminals 600 can be held by an insulative terminal holding member which together with the conductive terminals 600 constitutes a terminal assembly to be fitted into the insulative housing 500.

Although the contact tails of the conductive terminals are described here to be configured to be welded onto the conductive structures 32 (for example the conductive pads), it should be understood that the present disclosure is not limited to this. In some other embodiments, the contact tails of the conductive terminals can be in any other suitable form, for example can be in the form of a press fit “needle eye”.

### Connector Assembly

The electrical connector 10 can mate with the electrical connector 20 to form a connector assembly. This connector assembly can provide electrical connection between a circuit board 3 and another electrical component to accomplish signal and/or power transmission therebetween. Such a connector assembly can be referred to as “a wire-to-board assembly” or “a wire-to-board connector”. For example, such a connector assembly can be used as a BMS connector in a battery management system.

As shown by FIGS. 13A and 13B, when the electrical connector 10 mates with the electrical connector 20, the tongue portion 520 of the electrical connector 20 is received in the insulative housing 100 of the electrical connector 10 and the mating contact portions of the mating ends of the conductive terminals 600 are in electrical contact with the conductive contacts 203 of the flat cable member 200. Specifically, the mating contact portions 621a of the mating ends 621 of the conductive terminals 600 are in electrical contact with the conductive contacts 203 of the flat cable member 200. In this way, an electrical connection can be established between the flat cable member 200 of the electrical connector 10 and the conductive terminals 600 of the electrical connector 20. When the electrical connector 20 is installed on the circuit board 30, the conductive terminals 600 of the electrical connector 20 can establish an electrical connection between the flat cable member of the electrical connector 10 and a conductive structure of the circuit board 30 to connect the flat cable member to the circuit board 30.

The tongue portion 520 of the insulative housing 500 of the electrical connector 20 is received in the accommodation space 140 of the insulative housing 10 of the electrical connector 10, and is positioned and attached to the second segment 220 of the flat cable member 200 of the electrical connector 10. The accommodation portion 150 of the insulative housing 100 of the electrical connector 10 is received in the accommodation portion 540 of the insulative housing 500 of the electrical connector 20, and is positioned between the tongue portion 520 and the accommodation portion 540 of the insulative housing 500 of the electrical connector 20. Such a configuration can enable the insulative housing 100 of the electrical connector 10 and the insulative housing 500 of the electrical connector 20 to be tightly fitted together, and a labyrinth-type seal protection can be formed between an outer part of the connector assembly and a mating interface of the connector assembly to effectively prevent foreign matters from entering the mating interface.

The first wall 151 of the electrical connector 10 is received between the first wall 541 of the electrical connector 20 and the tongue portion 520. The second wall 152 of the electrical connector 10 and the second segment 220 of the flat cable member 200 are received between the second wall 542 of the electrical connector 20 and the tongue portion 520. The third wall 153 of the electrical connector 10 is received between the third wall 543 of the electrical connector 20 and the tongue portion 520. The fourth wall 154 of the electrical connector 10 is received between the fourth wall 544 of the electrical connector 20 and the tongue portion 520.

The first rib 171 and the second rib 172 of the electrical connector 10 are received by the first groove 561 and the second groove 562 of the electrical connector 20 respectively, and the first resilient beam 181 and the second resilient beam 182 of the overhanging structure 180 of the electrical connector 10 are received by the third groove 563 and the fourth groove 564 of the electrical connector 20 respectively. As already explained, such a configuration can improve the hot-plugging ability and reliability of the connector assembly.

For example, a connector is provided, which comprises a first connection assembly and a second connection assembly which is plug-in connected with the first connection assembly. The first connection assembly includes a first housing in which a first installation cavity is formed. The second connection assembly includes a second housing and a positioning snap provided in the second housing. The second housing is inserted into the first installation cavity, and is positioned via the positioning snap and connected to the first housing. A first surface of the second housing is formed with a positioning slide slot. The positioning slide slot includes two opposing sidewalls which form a positioning groove. The positioning snap includes a snap body and resilient arms disposed in opposing sides of the snap body. The resilient arms are provided with positioning bosses. The positioning snap is slidably installed in the positioning slide slot such that the positioning bosses are located in the positioning groove.

According to the connector provided by the present disclosure, the positioning design of the resilient arms can result in effective space saving and a reduced height, especially is adapted for meeting connection requirements for low-high connectors. Moreover, the positioning slide slot and the positioning groove are provided for positioning connection with the resilient arms and the positioning bosses, to effectively guarantee the connection reliability between the positioning snap and the second housing, thus, to improve the installation reliability of the connector.

### Embodiment One

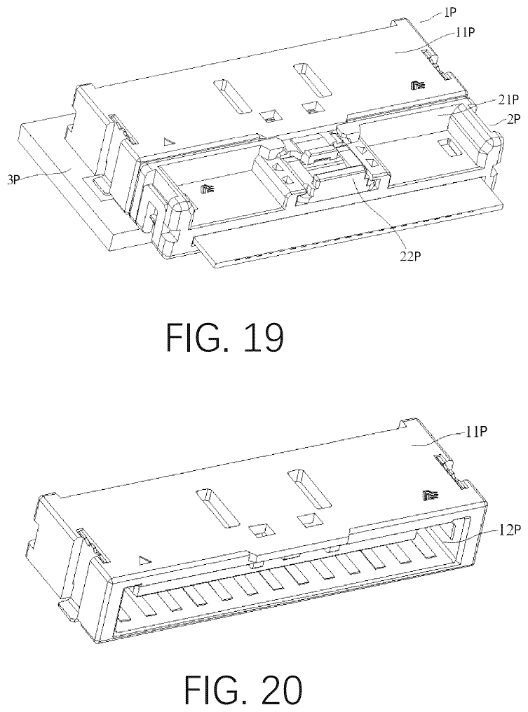

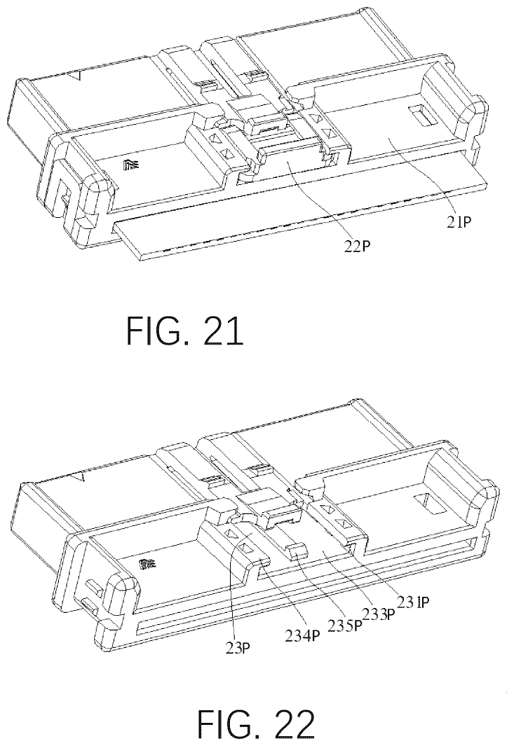

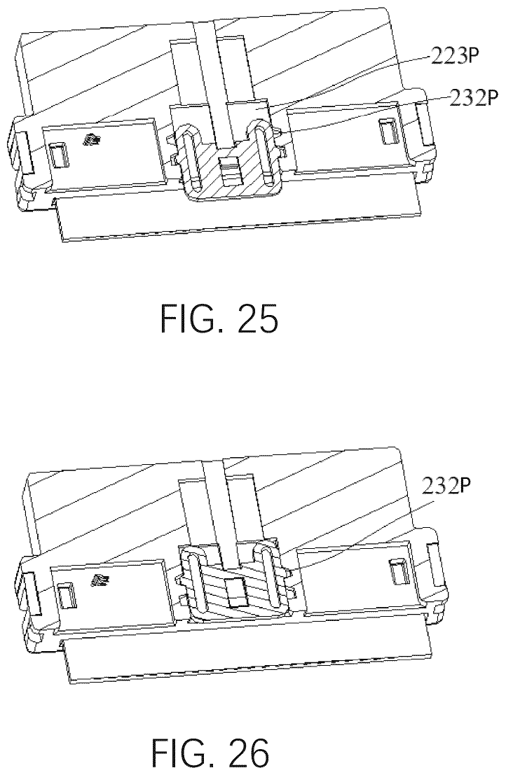

As shown by FIGS. 19 to 26, a connector comprises a first connection assembly (or an electrical connector) 1P and a second connection assembly (or an electrical connector) 2P which is plug-in connected with the first connection assembly 1P. After the first connection assembly 1P and the second connection assembly 2P are plug-in connected to each other to accomplish signal or electrical current transmission therebetween. Usually, the first connection assembly 1P is fixed in position. For example, the first connection assembly 1P can be installed on a PCB board 3P, and the first connection assembly 1P is releasably connected to the PCB board 3P. Different than the first connection assembly 1P, the second connection assembly 2P is changeable in position. When the signal or electrical current transmission is desired to be accomplished, it is only required to plug-in connect the second connection assembly 2P to the first connection assembly 1P.

The first connection assembly 1P includes a first housing (or an insulative housing) 11P. A first installation cavity (or an accommodation space) 12P is formed in the first housing 11P. The second connection assembly 2P includes a second housing (or an insulative housing) 21P and a positioning snap (or a latch member) 22P provided in the second housing 21P. The second housing 21P is inserted into the first installation cavity 12P, and positioned and connected to the first housing 11P via the positioning snap 22P. It can be understood that an internal space of the first installation cavity 12P is sized such that it can mate with a part of the profile of the second housing 21P which can be inserted into the internal space. After the second housing 21P is inserted in the first installation cavity 12P, it is positioned and connected to the first housing 11P via the positioning snap 22P.

A positioning slide slot 23P is formed in a first surface of the second housing 21P. Here, the first surface is a top surface of the second housing 21P. The positioning slide slot 23P is formed in the top surface of the second housing 21P. The positioning slide slot 23P includes two opposing sidewalls 231P. In order to facilitate the understanding, the two sidewalls here can be referred to as “a first sidewall” and “a second sidewall”. A positioning groove 232P is formed in each of the first and second sidewalls. The positioning snap 22P includes a snap body (or a base body) 221P and resilient arms 222P respectively disposed on two opposing sides of the snap body 221P. The resilient arms comprise a first resilient arm and a second resilient arm. Each of the first resilient arm and the second resilient arm is provided with a positioning boss (or a protrusion) 232P therein.

When the positioning snap 22P is being connected to the second housing 21P, the positioning snap 22P is slidably installed in the positioning slide slot 23P. For example, along a given installation direction, the positioning snap 22P is enabled to slide in the positioning slide slot 23P until the positioning bosses 223P of the first and second resilient arms are located in the positioning grooves (or recesses) 232P of the first and second sidewalls respectively.

It should be understood that in the embodiment the positioning snap 22P includes the snap body 221P and the resilient arms 222P disposed on the two opposing sides of the snap body 221P. The resilient arms 222P are elastic. The snap body 221P provides connection support for the resilient arms 222P. A distance between the two opposing sidewalls of the positioning slide slot 23P is normally equal to a distance between the two resilient arms 222P. In order to facilitate the understanding, the positioning boss 223P here is set to be at a central position of the resilient arm 222P. For example, when the positioning snap 22P is being slidably installed relative to the positioning slide slot 23P, one end of the resilient arm 222P first begins to be slid along and from a location of the sidewall of the positioning slide slot 23P; after the positioning boss 223P enters the positioning slide slot 23P, the resilient arm 222P is pressed to deform; after the positioning boss 223P is slid in the positioning slide slot 23P to a location corresponding to the positioning groove 232P, the positioning boss 223P is engaged into the positioning groove 232P under the elastic action of the resilient arm 222P. The positioning installation of the positioning snap 22P is accomplished to ensure the installation stability of the positioning snap 22P and the second 21P.

In the connector provided by the embodiment, the positioning snap 22P can be referred to as “CPA”, whose two opposing resilient arms 222P are fitted in the positioning slide slot 23P. When the resilient arms 222P are pressed in the positioning slide slot 23P, they will deform such that during continued sliding thereof the positioning bosses 223P can be engaged in the positioning grooves 232P respectively under the elastic action of the resilient arms 222P. In comparison with a conventional connector in which the CPA is installed and connected in a height direction, this can effectively result in space saving and a lowered height, and is especially adapted for meeting connection requirements for low-high connectors. Moreover, it can effectively ensure the connection stability between the positioning snap 22P and the second housing 21P to improve the connection stability of the connector.

### Embodiment Two

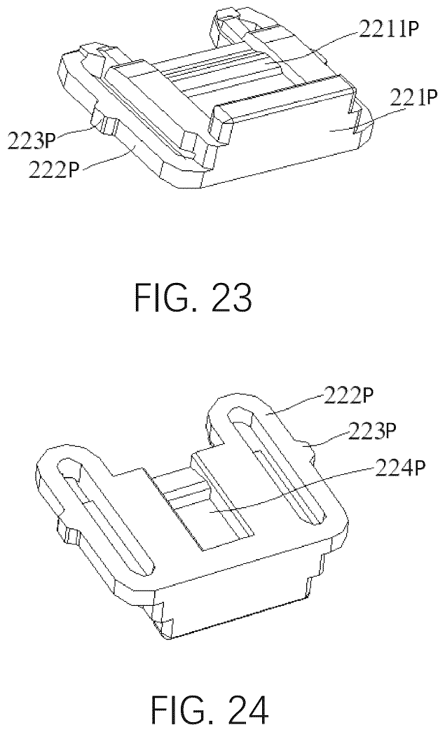

As shown by FIGS. 23 to 26, the positioning slide slot 23P further includes a first opening and a first bottom wall 233P opposing the first opening. Flanges 234P are formed in the sidewalls respectively. The resilient arms 222P are located between the first bottom wall 233P and the flanges 234P to limit the moving space of the resilient arms 222P and guide them, resulting in benefits of improved connection stability and installation convenience.

The installation orientation of the two resilient arms 222P in the horizontal direction is limited by the two opposing sidewalls of the positioning slide slot 23P and the moving travel of the resilient arms 222P in the vertical direction is restricted by cooperation of the flanges 234P with the first bottom wall 233P such that the installation and connection reliability between the positioning snap 22P and the second housing 21P can be further guaranteed. Furthermore, guide chutes can be formed between the flanges 234P and the first bottom wall 233P to guide the sliding installation of the positioning snap 22P.

In some embodiments, a positioning snap 235P is provided in the first bottom wall 233. The snap body 221P is provided with a positioning snap slot 224P for mating with the positioning snap 235P, to further improve the connection reliability between the positioning snap 22P and the second housing 21P and thus the stability in use of the connector.

In the connector configured according to the embodiment, the positioning slide slot 23P and the positioning grooves 232P are adopted to accomplish positioning connection of the resilient arms 222P and the positioning bosses 223P respectively, and further due to the positioning connection relationship of the positioning snap 235P and positioning snap slot 224P, the installation and connection stability between the positioning snap 22P and the second housing 21P can be further improved.

### Embodiment Three

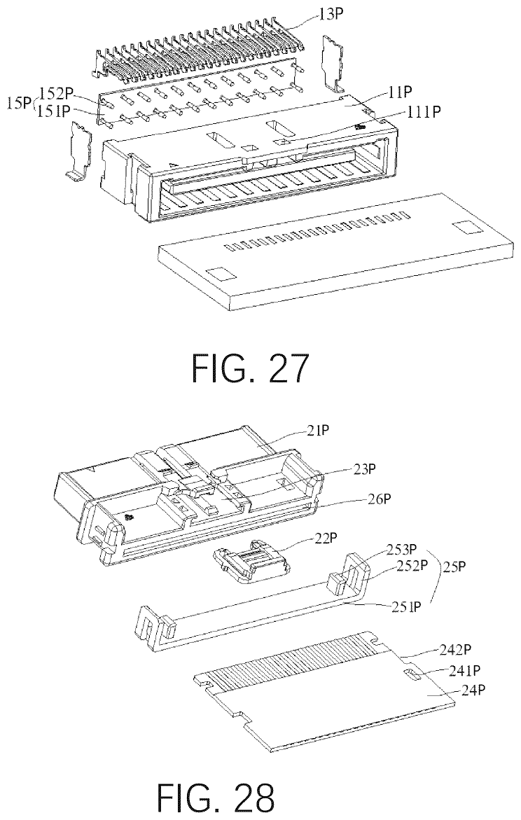

As shown by FIGS. 27 to 29, the first connection assembly 1P also includes connection terminals (or mating ends) 13P. The connection terminals 13P have a double-lever double-contact configuration. On the one hand, the double-lever and double-contact structured connection terminals 13P can meet the requirements of high current and multi-pin requirements. On the other hand, they can prevent foreign matters from passing therethrough, to ensure the stability of signal transmission and to be adapted for being used in an environment of high frequency vibration.

The second connection assembly 2P also includes an FPC flat cable 24P disposed in the second housing 21P. The connection terminals 13P are connected to the FPC flat cable 24P. After the second housing 21P is inserted in the first installation cavity 12P, connection between the FPC flat cable 24P and the connection terminals 13P is established to accomplish the function of transmitting signal and current of the connector.

### Embodiment Four

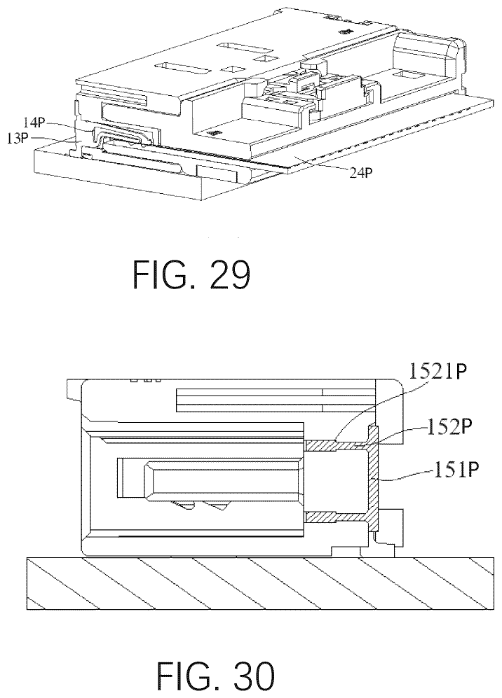

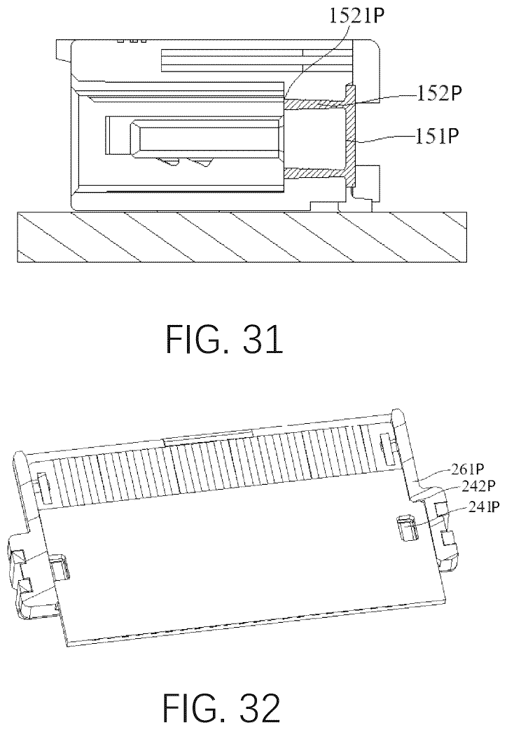

As shown by FIGS. 27 and 29, terminals slots 14P and a plastic-molded piece (or a seal cover) 15P are disposed in the first housing 11P. The terminal slots 14P include openings through which the connection terminals 13P are inserted into the terminal slots 14P. The plastic-molded piece 15P is used to seal the openings to prevent a liquid glue from permeating to contact points of the connection terminals 13P and thus affecting contact performance.

The contact points of the connection terminals 13P are inserted and located into the terminals slots 14P through the openings for connection with the second connection assembly 2P. Usually, parts of the connection terminals 13P exposed at the openings may be applied with the liquid glue, and the applied liquid glue may permeate to the contact points of the connection terminals 13P. Therefore, in this embodiment, by insertion molding the plastic-molded piece 15P at the openings, the openings can be sealed by the plastic-molded piece 15P such that the liquid glue cannot permeate to the contact points of the connection terminals 13P to ensure the contact performance.

In some embodiments, the plastic-molded piece 15P includes a seal face 151P and connection ribs (or pillars) 152P connected with the seal face 151P. The connection ribs 152P extend into the first housing 11P to improve the injection molding stability of the plastic-molded piece 15P and guarantee a sealing function of the plastic-molded piece 15P.

Specifically, an end of a connection rib 152P away from the seal face 151P is formed with an inverted feature 1521P. The inverted feature 1521P is used to prevent the connection rib 152P from escaping in a direction towards the seal face 151P, to guarantee the sealing function of the plastic-molded piece 15P. As shown by FIG. 30, the connection rib 152P includes a first portion away from seal face 151P and a second portion close to the seal face 151P. The first and second portions are cylindrical, and the first portion has a diameter greater than that of the second portion. The inverted feature 1521P can prevent the plastic-molded piece 15P from escaping in the direction towards the seal face 151P after the plastic-molded piece 15P has been formed by injection-molding. Similarly, as shown by FIG. 29, the connection rib 15P can be circular-truncated-cone shaped. The connection rib 15P has a diameter which gradually increases from a location close to the seal face 151P to a location away from the seal face 151P. This inverted feature 1521P also can prevent the plastic-molded piece 15P from escaping in the direction towards the seal face 151P after the plastic-molded piece 15P has been formed by injection-molding.

It should be understood that the embodiments do not constrain the concrete structure of the connection ribs 152P, as soon as they have the inverted feature 1521P and the inverted feature 1521P can prevent the plastic-molded piece 15P from escaping in the direction towards the seal face 151P.

### Embodiment Five

As shown by FIGS. 28 and 30, the second connection assembly 2P also comprises a snap piece (or latch member) 25P pre-locked to the second 21P. The snap piece 25P includes a press plate 251P, and a first fixation block (or arm) 252P and a second fixation block (or arm) 253P which extend from and adjacent to each end of the press plate 251P. The FPC flat cable 24P is formed with a first notch 241P respectively. The first fixation block 252P is cooperatively connected to the second housing 21P, and the second fixation block 253P is cooperatively connected to the first notch 241P. The FPC flat cable 24P can be lockably located in the second housing 21P by the snap piece 25P to ensure the installation stability of the FPC flat cable 24P.

For example, at least two limitation points are formed in a part of the second housing 21P facing towards the first fixation block 252P. When the first fixation block 252P arrives at a second one of the limitation points after passing a first one of the limitation points, the snap piece 25P can be locked to the second housing 21P and in the meanwhile the second fixation block 253P can cooperate with the first notch 241P to establish connection therebetween, such that the FPC flat cable 24P is lockably located in the second housing 21P.

The FPC flat cable 24P is also formed with a second notch 242P. A second installation cavity (or channel) 26P is formed in the second housing 21P. A fool-proof feature 261P is formed in the second installation cavity 26P to cooperate with the second notch 242P to prevent the FPC flat cable 24P from being installed in an inverted (or improper) manner.

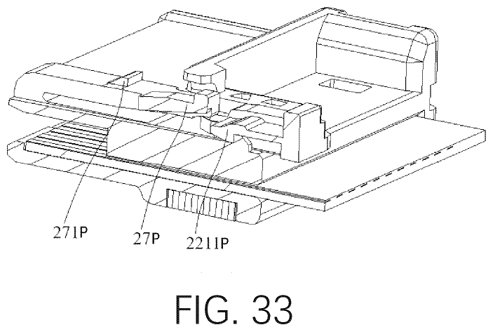

As shown by FIGS. 27 and 33, in some embodiments, the first surface of the second housing 21P is also formed with a floating connection arm (or overhanging structure) 27P for positioning and connecting the first housing 11P. The floating connection arm 27P is formed with at least two positioning blocks (or lock blocks) 271P therein. The first housing 11P is formed with positioning slots (or lock holes) 111P at locations corresponding to the positioning blocks 271P.

After the second housing 21P is inserted into the first installation cavity 12P, two positioning blocks 271P of the floating connection arm 27P can be limited in the positioning slots 111P of the first housing 11P such that the first housing 11P can be connected to the second housing 21P.

In order to further improve the connection stability between the first housing 11P and the second housing 21P, an abutting feature 2211P is formed in the snap body 221P for locking the floating connection arm 27P. After the second housing 21P is inserted into the first installation cavity 12P, the floating connection arm 27P can be still in a floating state under the action of external forces. Therefore, in this embodiment, as the abutting feature 2211P is formed in the snap body 221P, due to an abutting relation between the abutting feature 2211P and the floating connection arm 22P, the floating connection arm 22P can be prevented from floating after the second housing 21P is inserted into the first installation cavity 12P and the abutting feature 2211P has contacted the floating connection arm 27P. This can ensure the plug-in stability between the first housing 11P and the second housing 21P, to improve the stability in use of the connector.

The present disclosure provides a connection whose resilient arms are designed for positioning to effectively accomplish space saving and result in a lower height, especially adapted for meeting connection requirements for low-high connectors. Moreover, the positioning slide slot and the positioning groove are provided for positioning connection with the resilient arms and the positioning bosses, to effectively guarantee the connection reliability between the positioning snap and the second housing, thus, to improve the installation reliability of the connector.

A connector is provided, including a first connection assembly and a second connection assembly which is plug-in connected to the first connection assembly; the first connection assembly including a first housing in which a first installation cavity is formed, the second connection assembly including a second housing and a positioning snap piece disposed to the second housing, the second housing is inserted in the first installation cavity and is located and locked to the first housing via the positioning snap piece; a positioning slide slot is formed in a first surface of the second housing and includes two opposing sidewalls which are formed with positioning grooves, the positioning snap piece includes a snap body and resilient arms disposed on opposing sides of the snap body, the resilient arms are provided with positioning bosses thereon; the positioning is slidably installed in the positioning slide slot such that the positioning bosses are located in the positioning grooves.

In some embodiments, the positioning slide slot also includes a first opening and a first bottom wall facing towards the first opening, the sidewalls are formed with flange, the resilient arms are limited between the first bottom wall and the flanges.

In some embodiments, the first bottom wall is provided with a positioning snap therein, the snap body is provided with a positioning snap slot for cooperating with the positioning snap.

In some embodiments, the first connection assembly also includes connection terminals disposed to the first housing, which connection terminals have a double-lever double-contact configuration; the second connection assembly also includes an FPC flat cable disposed in the second housing, the connection terminals are connected to the FPC flat cable.

In some embodiments, terminal slots and a plastic-molded piece are provided in the first housing.

In some embodiments, the plastic-molded piece includes a seal face and connection ribs connected to the seal face, the connection ribs extend into the first housing.

In some embodiments, the connection ribs are formed with an inverted feature on ends thereof away from the seal face.

In some embodiments, the second housing also includes a snap piece pre-locked to the second housing, the snap piece includes a press plate, and first and second fixation blocks extending from and adjacent to ends of the press plate; the FPC flat cable is formed with a first notch, the first fixation block is cooperatively connected with the second housing, the second fixation block is cooperatively connected with the first notch, the FPC flat cable is lockably located in the second housing via the snap piece.

In some embodiments, the FPC flat cable is also formed with a second notch, the second housing is formed with a second installation cavity therein, the second installation cavity is formed with a fool-proof feature therein for cooperative connection with the second notch to prevent the FPC flat cable from inserting in an inverted manner.

In some embodiments, the first surface of the second housing is also formed with a floating connection arm for locating and connecting the first housing, the floating connection arm is formed with at least two positioning blocks, the first housing is formed with positioning slots at locations corresponding to the positioning blocks; the snap body is formed with an abutting feature for locking the floating connection arm.

Having thus described several embodiments, it is to be appreciated that various alterations, modifications, and improvements may readily occur to those skilled in the art.

It should also be appreciated that the terms “first”, “second”, “third”, “fourth”, “fifth”, “sixth”, “seventh”, and “eighth” are only used to distinguish an element, component or portion from another element, component or portion, and that these elements, components or portions should not be limited by such terms.

The present application has been described above in detail in conjunction with specific embodiments. Obviously, the above description and the embodiments shown in the appended drawings should be understood to be exemplary and do not constitute any limitations to the present application. For a skilled person in the art, various variations or modifications can be made without departing from the spirit of the present application, and these variations or modifications shall fall within the scope of the present application.

What is claimed is:

1. An electrical connector, comprising:
a housing comprising a space and a seal cover; and
a plurality of conductive terminals, each of the plurality of conductive terminals comprising a mating end in the space of the housing, a contact tail, and an intermediate portion between the mating end and the contact tail, wherein the contact tail comprises a portion embedded in the seal cover of the housing.

2. The electrical connector of claim 1, wherein the seal cover comprises a first side facing towards the housing, the first side comprising a plurality of integral pillars configured for engagement with the housing.

3. The electrical connector of claim 2, wherein the housing comprises a plurality of holes configured to receive the plurality of integral pillars of the seal cover.

4. The electrical connector of claim 3, wherein:
the housing comprises a base portion and an accommodation portion opposite to each other in a lateral direction, and a plurality of channels in the base portion such that they are spaced from each other in a longitudinal direction perpendicular to the lateral direction;
the plurality of conductive terminals are disposed in the plurality of channels; and
the first side of the seal cover faces towards the base portion and covers the plurality of channels.

5. The electrical connector of claim 4, wherein:
the seal cover comprises a second side opposite the first side; and
the electrical connector comprises a coating layer on at least the second side of the seal cover and enclosing portions of the contact tails of the plurality of conductive terminals.

6. The electrical connector of claim 5, wherein the coating layer is a high-temperature resistance coating layer and/or a coating layer of epoxy resin.

7. The electrical connector of claim 4, wherein:
the housing comprises a tongue portion extending from the base portion in the lateral direction;
the plurality of channels extend into the tongue portion; and
the contact tail of each of the plurality of conductive terminals protrudes at least partially from the tongue portion.

8. The electrical connector of claim 7, wherein:
the accommodation portion of the housing comprises a first wall and a second wall spaced from each other in a vertical direction perpendicular to both the longitudinal direction and the lateral direction, and a third wall and a fourth wall spaced from each other in the longitudinal direction;
the space of the housing is bounded by the first wall, the second wall, the third wall, and the fourth wall and configured for receiving a mating electrical connector; and
the first wall comprises a groove configured to receive a complementary feature of the mating electrical connector, and two lock holes.

9. The electrical connector of claim 8, wherein:
the mating end of each of the plurality of conductive terminals comprises a first beam and a second beam spaced from each other substantially in the vertical direction;
the first beam comprises a first end and a second end opposite to the first end, and a first straight segment joining the first end and the second end, the first end connected to the intermediate portion, a first contact portion of the first beam at the second end; and
the second beam comprises a third end and a fourth end opposite to the third end, a curved segment extending from the third end, and a second straight segment joining the curved segment and the fourth end, the third end connected to the intermediate portion, a second contact portion of the second beam at the fourth end.

10. An electrical connector, comprising:
a housing comprising a base portion and a first channel;
a flat cable member comprising a connection end in the first channel of the housing, the connection end comprising a plurality of conductive contacts; and
a first latch member coupled to the base portion of the housing and movable between a first pre-locked position and a first locked position relative to the housing, the first latch member configured to engage the connection end of the flat cable member in the first locked position and be separated from the connection end of the flat cable member in the first pre-locked position.

11. The electrical connector of claim 10, wherein:
the first latch member comprises a plate body and at least one first arm extending from the plate body in a vertical direction; and
the at least one first arm is configured to engage the connection end of the flat cable member in the first locked position and be separated from the connection end of the flat cable member in the first pre-locked position.

12. The electrical connector of claim 11, wherein:
the base portion of the housing comprises at least one aperture in communication with the first channel; and
the connection end of the flat cable member comprises at least one notch or slot configured to be aligned with the at least one aperture when the connection end of the flat cable member is inserted in the housing in place.

13. The electrical connector of claim 12, wherein:
the connection end of the flat cable member comprises a location port; and
the housing comprises a third arm extending from the base portion and comprising a snap portion configured to engage the location port of the connection end of the flat cable member when the connection end of the flat cable member is inserted in the housing in place.

14. The electrical connector of claim 10, wherein:
the connection end of the flat cable member comprises a first outer profile and a second outer profile opposite to the first outer profile in a longitudinal direction; and
the first outer profile is asymmetrical relative to the second outer profile such that the connection end of the flat cable member can be inserted in the first channel in only a predetermined orientation.

15. The electrical connector of claim 11, wherein the housing comprises:
an accommodation portion opposite to the base portion and extending in a lateral direction, the accommodation portion bounding a space in communication with the first channel; and
an overhanging structure integral with the accommodation portion, the overhanging structure comprising a first resilient beam, a second resilient beam, and a third beam joining free ends of the first and second resilient beams, and the first and second resilient beams extending towards the base portion in the lateral direction.

16. The electrical connector of claim 15, wherein:
the base portion of the housing comprises a pair of grooves spaced from each other in a longitudinal direction perpendicular to the lateral direction; and
the electrical connector comprises a second latch member movable along the pair of grooves between a second pre-locked position and a second locked position.

17. The electrical connector of claim 16, wherein:
the second latch member comprises a base body, a first resilient arm, and a second resilient arm, each of the first and second resilient arms comprising first and second ends opposite to each other in the lateral direction and connected to the base body, and a protrusion between the first and second ends; and
each groove of the pair of grooves comprises first and second recesses spaced from each other in the lateral direction, the first recess configured to receive the protrusion of a respective one of the first and second resilient arms at the second pre-locked position, and the second recess configured to receive the protrusion of the respective one of the first and second resilient arms at the second locked position.

18. A connector position assurance (CPA) device, comprising:
a base body;
a first resilient arm comprising first and second ends connected to the base body, a first intermediate portion between the first and second ends of the first resilient arm, the first intermediate portion separated from the base body; and
a second resilient arm comprising first and second ends connected to the base body, a second intermediate portion between the first and second ends of the second resilient arm, the second intermediate portion separated from the base body.

19. The CPA device of claim 18, wherein:
the first resilient arm comprises a first protrusion between first and second ends of the first resilient arm; and
the second resilient arm comprises a second protrusion between the first and second ends of the second resilient arm.

20. The CPA device of claim 19, wherein:
the base body comprises a guide slot configured to receive a guide tongue of a connector housing.
